(19) United States
(12) Patent Application Publication
(10) Pub. No.: US 2005/0138549 A1
(43) Pub. Date: Jun. 23, 2005

(54) Line-of-sight guiding degree calculation system and line-of-sight guiding degree calculation program as well as line-of-sight guiding degree calculation method

(75) Inventors: Naoki Kayahara, Chino-shi (JP); Atsushi Nagahara, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/973,427

(22) Filed: Oct. 27, 2004

(30) Foreign Application Priority Data
Oct. 29, 2003 (JP) 2003-369237
Aug. 25, 2004 (JP) 2004-244956

(51) Int. Cl. G06F 17/00

(52) U.S. Cl. 715/517

(57) ABSTRACT

Exemplary embodiments provide a line-of-sight guiding degree calculation system that can realize reduction in size and reduction in cost of an apparatus and can obtain an appropriate eye flow surely. First, a layout apparatus approximates an image object to a polygon on the basis of vector image data and detects respective apexes of the approximated image object as guiding reference points. Then, for each of the guiding reference points, the layout apparatus forms two auxiliary lines crossing the guiding reference point imaginarily along a contour of the image object and calculates a direction in which a bisector of an obtuse angle among angles formed by the imaginary auxiliary lines extends outward from the guiding reference point as a line-of-sight guiding direction. In addition, for each of the guiding reference points, the layout apparatus calculates a distance from a center of gravity G of the image object to the guiding reference point as a line-of-sight guiding intensity. Consequently, it can be calculated quantitatively and appropriately in which direction the image object tends to guide a line-of-sight.

### BACKGROUND OF THE INVENTION

1. Field of Invention

Exemplary embodiments of the present invention relate to a system and a program as well as a method to calculate a degree at which an image guides a line-of-sight. Exemplary embodiments further relate to a line-of-sight guiding degree calculation system and a line-of-sight guiding degree calculation program as well as a line-of-sight guiding degree calculation method that can realize reduction in size and reduction in cost of an apparatus and can obtain an appropriate eye flow.

2. Description of Related Art

A document with a high design property, in which layout elements (e.g., a title, an image, and a text) are laid out so as to be easily seen, such as a catalogue or the like for products, is called a visual document. Since creation of a visual document requires a lot of design know-how, it is difficult for a general businessperson to create a visual document. Therefore, creation of a visual document is often entrusted to a designer having a specialized knowledge about design.

When a designer creates a visual document, the designer arranges layout elements, which are continuous in meaning, in a direction in which a line-of-sight of a reader flows (hereinafter referred to as eye flow) to thereby realize a layout that is easily read. For example, if one article is constituted by a title, an image, and a text, it is preferable to arrange the title, the image, and the text such that an eye flow is in that order. Therefore, the designer carries out layout while repeating trial and error by arranging the layout elements and estimating an eye flow to rearrange the layout elements so as to be easily read. Since the designer estimates the eye flow on the basis of intuition and experiences, it is difficult to detect the eye flow quantitatively.

The related art discloses a technique to detect an eye flow and a technique related thereto. For example, there is a document design evaluation system disclosed in related art document JP-A-2002-175290, a line-of-sight information analysis apparatus disclosed in related art document JP-A-6-162, and an image recognition apparatus disclosed in related art document JP-A-2000-50051.

Related art document JP-A-2002-175290 discloses a system to evaluate design of a Web page, which includes a web data receiving unit that receives data of a Web page to be evaluated, a line-of-sight information receiving unit that receives line-of-sight information of a user looking at the Web page, and a design evaluating unit that evaluates design of the Web page on the basis of Web data received by the Web data receiving unit and line-of-sight information received by the line-of-sight information receiving unit.

Related art document JP-A-6-162 discloses detecting a movement of eyeballs with an eyeball movement detection apparatus, analyzes a change in time series of the eyeballs, which is detected by an analysis apparatus, in a frequency domain, analyzes contents of a displayed image inputted from an image input unit with a display content analysis apparatus, and subjects both the change in time series of the eyeballs and the contents of the image to integrated processing to thereby obtain data with high reliability about a psychological observation state of a subject and an objective evaluation with respect to the image.

In the case in which an original to be subjected to direction recognition is an original D2 in which characters are represented in void on a high density background image, related art document JP-A-2000-50051 reverses created histograms H3 and H4 to obtain histograms H1 and H2 and performs recognition of a direction of an original on the basis of the histograms after reversal.

### SUMMARY OF THE INVENTION

However, in related art documents JP-A-2002-175290 and JP-A-6-162, since the apparatus is constituted to detect an eye flow using a device such as an eye camera, there is a problem in that a size of the apparatus increases and a large amount of cost is required. In addition, in the case in which a designer carries out layout while detecting an eye flow of the designer himself/herself using the inventions described in related art documents JP-A-2002-175290 and JP-A-6-162, the designer adjusts himself/herself to a layout result by repeatedly looking at similar layout results or is conscious of an eye flow that the designer expects. Thus, it is likely that an eye flow at the time when others look at the layout result for the first time and an eye flow of the designer that is actually detected are inconsistent. Since the designer aims to realize a layout that is easy to read for a reader who takes the layout result for the first time, what the designer needs is an eye flow of a person who looks at the layout result for the first time. Therefore, there is a problem in that, even if the designer carries out layout while detecting an eye flow of the designer himself/herself, it is difficult to obtain an appropriate eye flow and it is difficult to realize a layout that is easy to read.

In addition, related art document JP-A-6-162 learns a correspondence between an image characteristic amount extracted from an image of a visual document and a line-of-sight characteristic amount of movement of a line-of-sight that is measured using a measurement device at the time when the image is shown to a subject. Then, after results of the learning are accumulated, if only an image characteristic amount is given, a line-of-sight characteristic amount can be estimated on the basis of the given image characteristic amount and the results of the learning. However, since a method of the learning is adopted, although an appropriate eye flow is obtained if the given image characteristic amount is a learned image characteristic amount, an appropriate eye flow cannot be obtained if the given image characteristic amount is not a learned image characteristic amount. Therefore, there is a problem in that sufficient reliability cannot be obtained unless the learning is performed many times.

Further, in related art document JP-A-2000-50051, it is only judged whether an image is lengthwise or sideways, and an eye flow cannot be detected.

Thus, exemplary embodiments of the present invention have been devised in view of such unsolved problems inherent in the related art techniques. Exemplary embodiments provide a line-of-sight guiding degree calculation system and a line-of-sight guiding degree calculation program as well as a line-of-sight guiding degree calculation method that can realize reduction in size and reduction in cost of an apparatus and also can obtain an appropriate eye flow surely.

In order to apply an eye flow to a layout, first, when attention is paid to one layout element, it is necessary to quantitatively find in which direction the layout element tends to guide a line-of-sight.

As a result of earnestly repeating examinations, the inventors have found that, in the case in which an image object having a projected part is observed, a sense of a human has a characteristic that a line-of-sight tends to be guided to the projected part from the inside of the image object (direction characteristic) and a characteristic that, as a sharpness degree of the projected part is larger, a line-of-sight tends to be guided more to the projected part (intensity characteristic). Therefore, the inventors has reached a conclusion that, if a degree of guiding a line-of-sight is obtained on the basis of characteristics that a line-of-sight is guided by a predetermined magnitude in a predetermined direction with points near apexes of the projected part set as references, it can be quantitatively found in which direction a layout element tends to guide a line-of-sight.

In addition, in the case in which an image object having a projected part is included in an image, a line-of-sight guiding degree of the image can be obtained on the basis of the characteristics. However, in the case in which an image object does not have a clear projected part or in the case in which a contour of an image object is complicated, a line-of-sight guiding degree of an image cannot be obtained easily. In this case, it is desirable to obtain a line-of-sight guiding degree of an image after approximating a bent part of the image object to a projected part.

[First Exemplary Embodiment] In order to address or attain the above object, a line-of-sight guiding degree calculation system of a first exemplary embodiment is a system to calculate a degree, at which a line-of-sight is guided by an image, on the basis of image data constituting the image, characterized by including:
a projected part approximating device that approximates a bent part including a curved line included in the image to a projected part including apexes on the basis the image data; and a line-of-sight guiding degree calculating device that, with the apexes included in the projected part approximated by the projected part approximating device set as guiding reference points, calculates a light-of-sight guiding degree, at which a line-of-sight is guided, with respect to the guiding reference points.

With such a constitution, a bent part included in an image is approximated to a projected part by the projected part approximating device on the basis of image data, and with apexes included in the projected part approximated by the projected part approximating device set as guiding reference points, a line-of-sight guiding degree is calculated by the line-of-sight guiding degree calculating device with respect to the guiding reference points.

A line-of-sight tends to be guided from the inside of an image object to a projected part. Therefore, by approximating a bent part to a projected part and setting apexes included in the projected part as guiding reference points, even if an image does not include a clear projected part, it can be calculated quantitatively and relatively appropriately in which direction the image tends to guide a line-of-sight. Thus, there is an advantage that a relatively appropriate eye flow can be obtained quantitatively compared with the related art techniques. In addition, since it is unnecessary to separately provide a device such as an eye camera, an apparatus is never increased in size and large cost is never incurred, and there is also an advantage that reduction in size of and reduction in cost the apparatus can be realized compared with the related art techniques. Moreover, since a line-of-sight guiding degree is not calculated by a method of learning, there is also an advantage that an appropriate eye flow can be obtained relatively surely.

Here, the system may be realized as a single apparatus, terminal, or other device or may be realized as a network system in which plural apparatuses, terminals, or other devices are connected so as to be capable of communicating with each other. In the latter case, respective components may belong to any one of the plural devices or the like as long as the components are connected so as to be capable of communicating with each other.

[Second Exemplary Embodiment] A line-of-sight guiding degree calculation system of a second exemplary embodiment is characterized in that, in the line-of-sight guiding degree calculation system of the first exemplary embodiment,
the projected part approximating device subjects the bent part to polygon approximation.

With such a constitution, a bent part is subjected to polygon approximation by the projected part approximating device.

Consequently, since the bent part can be approximated to a projected part of a relatively similar shape, there is an advantage that, even if an image does not include a clear projected part, it can be calculated more appropriately in which direction the image tends to guide a line-of-sight.

[Third Exemplary Embodiment] A line-of-sight guiding degree calculation system of a third exemplary embodiment is characterized in that, in the line-of-sight guiding degree calculation system of the first or the second exemplary embodiment,
the projected part approximating device sets one or plural auxiliary points between both end points of the bent part and on an edge of the bent part and approximates a shape, which is formed by connecting points adjacent to each other on the edge among both the end points of the bent part and the auxiliary points with lines, as the projected part.

With such a constitution, one or more auxiliary points are set between both end points of a bent part and on an edge of the bent part by the projected part approximating device, and a shape, which is formed by connecting points adjacent to each other on the edge among both the end points of the bent part and the auxiliary points with lines, is approximated as a projected part.

Consequently, since the bent part can be approximated to a projected part of a relatively similar shape, there is an advantage that, even if an image does not include a clear projected part, it can be calculated more appropriately in which direction the image tends to guide a line-of-sight.

[Fourth Exemplary Embodiment] A line-of-sight guiding degree calculation system of a fourth exemplary embodiment is characterized in that, in the line-of-sight guiding degree calculation system of the second or the third exemplary embodiment,
the projected part approximating device includes: a first auxiliary point setting device that sets the auxiliary points in positions where distances from a straight line connecting both the end points of the bent part to the edge are maximized; and a second auxiliary point setting device that sets the auxiliary points in positions where a distance from straight lines connecting points adjacent to each other on the edge among both the end points of the bent part and the auxiliary points to the edge is maximized, and approximates a polygon, which is formed by connecting points adjacent to each other on the edge among both the end points of the bent part and the auxiliary points with straight lines, as the projected part.

With such a constitution, auxiliary points are set in positions, where distances from a straight line connecting both end points of a bent part to an edge are maximized, by the first auxiliary point setting device. In addition, the auxiliary points are set in positions, where a distance from straight lines connecting points adjacent to each other on the edge among both the end points of the bent part and the auxiliary points is maximized, by the second auxiliary point setting device. When the auxiliary points are set in this way, a polygon, which is formed by connecting points adjacent to each other on the edge among both the end points of the bent part and the auxiliary points with straight lines, is approximated as a projected part by the projected part approximating device.

Consequently, the bent part can be approximated to a projected part of a relatively similar shape and can be approximated as a polygon for which a line-of-sight guiding degree is easily obtained. Thus, there is an advantage that, even if an image does not include a clear projected part, it can be calculated more appropriately in which direction the image tends to guide a line-of-sight.

[Fifth Exemplary Embodiment] A line-of-sight guiding degree calculation system of a fifth exemplary embodiment is characterized in that, in the line-of-sight guiding degree calculation system of the fourth exemplary embodiment,
the projected part approximating device performs the setting by the second auxiliary point setting device repeatedly until a distance between the bent part and the polygon is reduced to a predetermined distance or less.

With such a constitution, the setting by the second auxiliary point setting device is performed repeatedly by the projected part approximating device until a distance between a bent part and a polygon is reduced to a predetermined distance or less, and a polygon, which is formed by connecting points adjacent to each other on an edge among both end points of the bent part and auxiliary points with straight lines, is approximated as a projected part.

Consequently, since the bent part can be approximated to a projected part of a similar shape, there is an advantage that, even if an image does not include a clear projected part, it can be calculated more appropriately in which direction the image tends to guide a line-of-sight.

Here, the distance refers to a distance from straight lines connecting the points adjacent to each other on the edge among both the end points of the bent part and the auxiliary points to the auxiliary points set in positions where a distance to the edge is maximized.

[Sixth Exemplary Embodiment] A line-of-sight guiding degree calculation system of a sixth exemplary embodiment is characterized in that, in the line-of-sight guiding degree calculation system of any one of the first to the fifth exemplary embodiments,
the line-of-sight guiding degree calculating device calculates, with apexes of the projected part approximated by the projected part approximating device or vicinities thereof set as guiding reference points, the line-of-sight guiding degree with respect to the guiding reference points.

With such a constitution, with apexes of a projected part approximated by the projected part approximating device or vicinities thereof set as guiding reference points, the line-of-sight guiding degree is calculated with respect to the guiding reference points.

In the case in which an image object having a projected part is included in an image, a line-of-sight tends to be guided from the inside of the image object toward the projected part. Therefore, by setting apexes of the projected part and vicinities thereof as guiding reference points, there is an advantage that it can be calculated more appropriately in which direction an image tends to guide a line-of-sight.

From a viewpoint of obtaining an appropriate eye flow, it is preferable to set apexes of a projected part as guiding reference points. However, in the case in which it is difficult to specify apexes of a projected part or in the case in which an eye flow is obtained at low accuracy from a viewpoint of reduction in an amount of calculation or the like, vicinities of the apexes of the projected part may be set as guiding reference points in a range in which an inappropriate eye flow is not obtained.

[Seventh Exemplary Embodiment] A line-of-sight guiding degree calculation system of a seventh exemplary embodiment is characterized in that, in the line-of-sight guiding degree calculation system of any one of the first to the sixth exemplary embodiments,
the line-of-sight guiding degree calculating device includes: line-of-sight guiding direction calculating device that calculates line-of-sight guiding directions, which are directions in which a line-of-sight is guided, with respect to the guiding reference points; and line-of-sight guiding intensity calculating device that calculates line-of-sight guiding intensities, which are intensities at which a line-of-sight is guided, with respect to the guiding reference points.

With such a constitution, line-of-sight guiding directions are calculated with respect to guiding reference points by the line-of-sight guiding direction calculating device, and line-of-sight guiding intensities are calculated with respect to the guiding reference points by the line-of-sight guiding intensity calculating device. In other words, it is possible to calculate the line-of-sight guiding directions and the line-of-sight guiding intensities as line-of-sight guiding degrees.

In the case in which an image object having a projected part is included in an image, a line-of-sight tends to be guided at a predetermined magnitude in a predetermined direction with points near apexes of the projected part as references. Therefore, by calculating line-of-sight guiding directions and line-of-sight guiding intensities as line-of-sight guiding degrees, there is an advantage that it can be calculated more appropriately in which direction the image tends to guide a line-of-sight.

[Eighth Exemplary Embodiment] A line-of-sight guiding degree calculation system of an eighth exemplary embodiment is characterized in that, in the line-of-sight guiding degree calculation system of the seventh exemplary embodiment,
in the case in which it is assumed that two auxiliary lines crossing the guiding reference points or the vicinities thereof are formed along an edge of an image passing the guiding reference points or the vicinities thereof, the line-of-sight guiding direction calculating device calculates center directions of obtuse angles among angles formed by the imaginary auxiliary lines as the line-of-sight guiding directions.

With such a constitution, in the case in which it is assumed that two auxiliary lines crossing the guiding reference points or the vicinities thereof are formed along an edge of an image passing the guiding reference points or the vicinities thereof, center directions of obtuse angles among angles formed by the imaginary auxiliary lines are calculated as the line-of-sight guiding directions by the line-of-sight guiding direction calculating device.

Consequently, since directions from the inside of an image object toward apexes of a projected part can be calculated as line-of-sight guiding directions, there is an advantage that it can be calculated more appropriately in which direction an image tends to guide a line-of-sight.

Here, assuming that imaginary auxiliary lines crossing guiding reference points or vicinities thereof are formed along an edge of an image, the line-of-sight guiding direction calculating device calculates line-of-sight guiding directions. From a viewpoint of obtaining an appropriate eye flow, it is preferable to calculate line-of-sight guiding directions assuming that imaginary auxiliary lines crossing guiding reference points are formed along an edge of an image. However, in the case in which it is difficult to form imaginary auxiliary lines crossing guiding reference points in terms of calculation or in the case in which an eye flow is obtained at low accuracy from a viewpoint of reduction in an amount of calculation or the like, line-of-sight guiding directions may be calculated assuming that imaginary auxiliary lines crossing vicinities of guiding reference points are formed along an edge of an image in a range in which an inappropriate eye flow is not obtained.

[Ninth Exemplary Embodiment] A line-of-sight guiding degree calculation system of a ninth exemplary embodiment is characterized in that, in the line-of-sight guiding degree calculation system of any one of the seventh and the eighth exemplary embodiment,
the line-of-sight guiding degree calculating device calculates distances from a center of gravity of an image object, a contour of which is formed including an edge of an image passing the guiding reference points or the vicinities thereof, to the guiding reference points as the line-of-sight guiding intensities.

With such a constitution, distances from a center of gravity of an image object, a contour of which is formed including an edge of an image passing guiding reference points or vicinities thereof, to the guiding reference points are calculated as line-of-sight guiding intensities by the line-of-sight guiding degree calculating device.

As a sharpness degree of a projected part of an image object is larger, a line-of-sight tends to be guided more to the projected part. In addition, distances from a center of gravity of the image object to guiding reference points increase as the sharpness degree is larger. Therefore, since line-of-sight guiding intensities corresponding to magnitudes of the sharpness degree of the projected part of the image object can be calculated, there is an advantage that it can be calculated more appropriately in which direction an image guides a line-of-sight.

Here, the image object refers to an area having a contour in an image. This area may be a closed area or an open area. The same holds true for line-of-sight guiding degree calculation systems of tenth and eleventh exemplary embodiments to be described below.

[Tenth Exemplary Embodiment] A line-of-sight guiding degree calculation system of a tenth exemplary embodiment is characterized in that, in the line-of-sight guiding degree calculation system of any one of the seventh to the ninth exemplary embodiments,
in the case in which it is assumed that two auxiliary lines crossing the guiding reference points or the vicinities thereof are formed along an edge of an image passing the guiding reference points or the vicinities thereof, the line-of-sight guiding intensity calculating device calculates distances from points where bisectors of acute angles among angles formed by the imaginary auxiliary lines cross a contour line of an image object, a contour of which is formed including the edge, to the guiding reference points as the line-of-sight guiding intensities.

With such a constitution, in the case in which it is assumed that two auxiliary lines crossing guiding reference points or vicinities thereof are formed along an edge of an image passing the guiding reference points or the vicinities thereof, distances from points where bisectors of acute angles among angles formed by the imaginary auxiliary lines cross a contour line of an image object, a contour of which is formed including the edge, to the guiding reference points are calculated as line-of-sight guiding intensities by the line-of-sight guiding intensity calculating device.

As a sharpness degree of a projected part of an image object is larger, a line-of-sight tends to be guided more to the projected part. In addition, distances from points where bisectors of acute angles among angles formed by imaginary auxiliary lines crosses a contour line of an image object to guiding reference points increase as the sharpness degree is larger. Therefore, since line-of-sight guiding intensities corresponding to magnitudes of the sharpness degree of the projected part of the image object can be calculated, there is an advantage that it can be calculated more appropriately in which direction an image tends to guide a line-of-sight.

Here, assuming that imaginary auxiliary lines crossing guiding reference points or vicinities thereof are formed along an edge of an image, the line-of-sight guiding intensity calculating device calculates line-of-sight guiding intensities. From a viewpoint of obtaining an appropriate eye flow, it is preferable to calculate line-of-sight guiding intensities assuming that imaginary auxiliary lines crossing guiding reference points are formed along an edge of an image. However, in the case in which it is difficult to form imaginary auxiliary lines crossing guiding reference points in terms of calculation or in the case in which an eye flow is obtained at low accuracy from a viewpoint of reduction in an amount of calculation or the like, line-of-sight guiding intensities may be calculated assuming that imaginary auxiliary lines crossing vicinities of guiding reference points are formed along an edge of an image in a range in which an inappropriate eye flow is not obtained. The same holds true for a line-of-sight guiding degree calculation system of an eleventh exemplary embodiment to be described below.

[Eleventh Exemplary Embodiment] A line-of-sight guiding degree calculation system of an eleventh exemplary embodiment is characterized in that, in the line-of-sight guiding degree calculation system of any one of the seventh to the tenth exemplary embodiments,
in the case in which it is assumed that two auxiliary lines crossing the guiding reference points or the vicinities thereof are formed along an edge of an image passing the guiding reference points or the vicinities thereof, the line-of-sight guiding intensity calculating device calculates angles formed by the imaginary auxiliary lines as the line-of-sight guiding intensities.

With such a constitution, in the case in which it is assumed that two auxiliary lines crossing guiding reference points or vicinities thereof are formed along an edge of an image passing the guiding reference points or the vicinities thereof, angles formed by the imaginary auxiliary lines are calculated as a line-of-sight guiding intensities by the line-of-sight guiding intensity calculating device.

As a sharpness degree of a projected part of an image object is larger, a line-of-sight tends to be guided more to the projected part. In addition, the angles formed by the imaginary auxiliary lines are smaller as the sharpness degree is larger. Therefore, since line-of-sight guiding intensities corresponding to magnitudes of the sharpness degree of the projected part of the image object can be calculated, there is an advantage that it can be calculated more appropriately in which direction an image tends to guide a line-of-sight.

[Twelfth Exemplary Embodiment] On the other hand, in order to attain the object, a line-of-sight guiding degree calculation program of a twelfth exemplary embodiment is a program to calculate a degree, at which a line-of-sight is guided by an image, on the basis of image data constituting the image, characterized by including:
a program for causing a computer to execute processing including: approximating a bent part including a curved line included in the image to a projected part including apexes on the basis of the image data; and with the apexes included in the projected part approximated in the projected part approximating step set as guiding reference points, calculating line-of-sight guiding degrees indicating degrees, at which a line-of-sight is guided, with respect to the guiding reference points.

With such a constitution, when the program is read by the computer, and the computer executes the processing in accordance with the read program, an action and an advantage equivalent to those in the line-of-sight guiding degree calculation system of the first exemplary embodiment are obtained.

[Thirteenth Exemplary Embodiment] A line-of-sight guiding degree calculation program of a thirteenth exemplary embodiment is characterized in that, in the line-of-sight guiding degree calculation program of the twelfth exemplary embodiment,
the bent part is subjected to polygon approximation in the projected part approximating.

With such a constitution, when the program is read by the computer, and the computer executes the processing in accordance with the read program, an action and an advantage equivalent to those in the line-of-sight guiding degree calculation system of the second exemplary embodiment are obtained.

[Fourteenth Exemplary Embodiment] A line-of-sight guiding degree calculation program of a fourteenth exemplary embodiment is characterized in that, in the line-of-sight guiding degree calculation program of the twelfth or the thirteenth exemplary embodiment,
in the projected part approximating, one or more auxiliary points are set between both end points of the bent part and on an edge of the bent part, and a shape, which is formed by connecting points adjacent to each other on the edge among both the end points of the bent part and the auxiliary points with lines, is approximated as the projected part.

With such a constitution, when the program is read by the computer, and the computer executes the processing in accordance with the read program, an action and an advantage equivalent to those in the line-of-sight guiding degree calculation system of the third exemplary embodiment are obtained.

[Fifteenth Exemplary Embodiment] A line-of-sight guiding degree calculation program of a fifteenth exemplary embodiment is characterized in that, in the line-of-sight guiding degree calculation program of the thirteenth or the fourteenth exemplary embodiment,
the projected part approximating includes: setting the auxiliary points in positions where distances from a straight line connecting both the end points of the bent part to the edge are maximized; and setting the auxiliary points in positions where distances from straight lines connecting points adjacent to each other on the edge among both the end points of the bent part and the auxiliary points to the edge are maximized, and a polygon, which is obtained by connecting the points adjacent to each other on the edge among both the end points of the bent part and the auxiliary points with straight lines, is approximated as the projected part.

With such a constitution, when the program is read by the computer, and the computer executes the processing in accordance with the read program, an action and an advantage equivalent to those in the line-of-sight guiding degree calculation system of the fourth exemplary embodiment are obtained.

[Sixteenth Exemplary Embodiment] A line-of-sight guiding degree calculation program of a sixteenth exemplary embodiment is characterized in that, in the line-of-sight guiding degree calculation program of the fifteenth exemplary embodiment,
in the projected part approximating, the setting in the second auxiliary point setting is performed repeatedly until a distance between the bent part and the polygon is reduced to a predetermined distance or less.

With such a constitution, when the program is read by the computer, and the computer executes the processing in accordance with the read program, an action and an advantage equivalent to those in the line-of-sight guiding degree calculation system of the fifth exemplary embodiment are obtained.

[Seventeenth Exemplary Embodiment] A line-of-sight guiding degree calculation program of a seventeenth exemplary embodiment is characterized in that, in the line-of-sight guiding degree calculation program of any one of the twelfth to the sixteenth exemplary embodiments,
in the line-of-sight guiding degree calculating, with the apexes of the projected part approximated in the projected part approximating device or the vicinities thereof set as guiding reference points, the line-of-sight guiding degrees are calculated with respect to the guiding reference points.

With such a constitution, when the program is read by the computer, and the computer executes the processing in accordance with the read program, an action and an advantage equivalent to those in the line-of-sight guiding degree calculation system of the sixth exemplary embodiment are obtained.

[Eighteenth Exemplary Embodiment] A line-of-sight guiding degree calculation program of an eighteenth exemplary embodiment is characterized in that, in the line-of-sight guiding degree calculation program of any one of the twelfth to the seventeenth exemplary embodiments,
the line-of-sight guiding degree calculating includes: a line-of-sight guiding direction calculating device to calculate line-of-sight guiding directions, which are directions in which a line-of-sight is guided, with respect to the guiding reference points; and a line-of-sight guiding intensity calculating device to calculate line-of-sight guiding intensities, which are intensities at which a line-of-sight is guided, with respect to the guiding reference points.

With such a constitution, when the program is read by the computer, and the computer executes the processing in accordance with the read program, an action and an advantage equivalent to those in the line-of-sight guiding degree calculation system of the seventh exemplary embodiment are obtained.

[Nineteenth Exemplary Embodiment] A line-of-sight guiding degree calculation program of a nineteenth exemplary embodiment is characterized in that, in the line-of-sight guiding degree calculation program of the eighteenth exemplary embodiment,
in the line-of-sight guiding direction calculating, in the case in which it is assumed that two auxiliary lines crossing the guiding reference points or the vicinities thereof are formed along an edge of an image passing the guiding reference points or the vicinities thereof, center directions of obtuse angles among angles formed by the imaginary auxiliary lines are calculated as the line-of-sight guiding directions.

With such a constitution, when the program is read by the computer, and the computer executes the processing in accordance with the read program, an action and an advantage equivalent to those in the line-of-sight guiding degree calculation system of the eighth exemplary embodiment are obtained.

[Twentieth Exemplary Embodiment] A line-of-sight guiding degree calculation program of a twentieth exemplary embodiment is characterized in that, in the line-of-sight guiding degree calculation program of the eighteenth or the nineteenth exemplary embodiment,
in the line-of-sight guiding intensity calculating, distances from a center of gravity of an image object, a contour of which is formed including an edge of an image passing the guiding reference points or the vicinities thereof, to the guiding reference points are calculated as the line-of-sight guiding intensities.

With such a constitution, when the program is read by the computer, and the computer executes the processing in accordance with the read program, an action and an advantage equivalent to those in the line-of-sight guiding degree calculation system of the ninth exemplary embodiment are obtained.

[Twenty-first Exemplary Embodiment] A line-of-sight guiding degree calculation program of a twenty-first exemplary embodiment is characterized in that, in the line-of-sight guiding degree calculation program of any one of the eighteenth to the twentieth exemplary embodiments,
in the line-of-sight guiding intensity calculating, in the case in which it is assumed that two auxiliary lines crossing the guiding reference points or the vicinities thereof are formed along an edge of an image passing the guiding reference points or the vicinities thereof, distances from points where bisectors of acute angles among angles formed by the imaginary auxiliary lines cross a contour line of an image object, a contour of which is formed including the edge, to the guiding reference points are calculated as the line-of-sight guiding intensities.

With such a constitution, when the program is read by the computer, and the computer executes the processing in accordance with the read program, an action and an advantage equivalent to those in the line-of-sight guiding degree calculation system of the tenth exemplary embodiment are obtained.

[Twenty-second Exemplary Embodiment] A line-of-sight guiding degree calculation program of a twenty-second exemplary embodiment is characterized in that, in the line-of-sight guiding degree calculation program of any one of the eighteenth to the twenty-first exemplary embodiments,
in the line-of-sight guiding intensity calculating, in the case in which it is assumed that two auxiliary lines crossing the guiding reference points or the vicinities thereof are formed along an edge of an image passing the guiding reference points or the vicinities thereof, angles formed by the imaginary auxiliary lines are calculated as the line-of-sight guiding intensities.

With such a constitution, when the program is read by the computer, and the computer executes the processing in accordance with the read program, an action and an advantage equivalent to those in the line-of-sight guiding degree calculation system of the eleventh exemplary embodiment are obtained.

[Twenty-third Exemplary Embodiment] On the other hand, in order to attain the above object, a line-of-sight guiding degree calculation method of a twenty-third exemplary embodiment is a method of calculating degrees, at which a line-of-sight is guided by an image, on the basis of image data constituting the image, characterized by including:
approximating a bent part including a curved line included in the image to a projected part including apexes on the basis of the image data; and with the apexes included in the projected part approximated in the projected part approximating set as guiding reference points, calculating line-of-sight guiding degrees indicating degrees, at which a line-of-sight is guided, with respect to the guiding reference points.

Consequently, an advantage equivalent to that in the line-of-sight guiding degree calculation system of the first exemplary embodiment is obtained.

Twenty-fourth Exemplary Embodiment] A line-of-sight guiding degree calculation method of a twenty-fourth exemplary embodiment is characterized in that, in the line-of-sight guiding degree calculation method of the twenty-third exemplary embodiment,
in the projected part approximating, the bent part is subjected to polygon approximation.

Consequently, an advantage equivalent to that in the line-of-sight guiding degree calculation system of the second exemplary embodiment is obtained.

[Twenty-fifth Exemplary Embodiment] A line-of-sight guiding degree calculation method of the twenty-fifth exemplary embodiment is characterized in that, in the line-of-sight guiding degree calculation method of the twenty-third or the twenty-fourth exemplary embodiment,
in the projected part approximating, one or more auxiliary points are set between both end points of the bent part and on an edge of the bent part, and a shape, which is formed by connecting points adjacent to each other on the edge among both the end points of the bent part and the auxiliary points with lines, is approximated as the projected part.

Consequently, an advantage equivalent to that in the line-of-sight guiding degree calculation system of the third exemplary embodiment is obtained.

[Twenty-sixth Exemplary Embodiment] A line-of-sight guiding degree calculation method of a twenty-sixth exemplary embodiment is characterized in that, in the line-of-sight guiding degree calculation method of the twenty-fourth or the twenty-fifth exemplary embodiment,
the projected part approximating includes: setting the auxiliary points in positions where distances from a straight line connecting both the end points of the bent part to the edge are maximized; and setting the auxiliary points in positions where distances from straight lines connecting points adjacent to each other on the edge among both the end points of the bent part and the auxiliary points to the edge are maximized, and a polygon, which is obtained by connecting the points adjacent to each other on the edge among both the end points of the bent part and the auxiliary points with straight lines, is approximated as the projected part.

Consequently, an advantage equivalent to that in the line-of-sight guiding degree calculation system of the fourth exemplary embodiment is obtained.

[Twenty-seventh Exemplary Embodiment] A line-of-sight guiding degree calculation method of a twenty-seventh exemplary embodiment is characterized in that, in the line-of-sight guiding degree calculation method of the twenty-sixth exemplary embodiment,
in the projected part approximating, the setting in the second auxiliary point setting device is performed repeatedly until a distance between the bent part and the polygon is reduced to a predetermined distance or less.

Consequently, an advantage equivalent to that in the line-of-sight guiding degree calculation system of the fifth exemplary embodiment is obtained.

[Twenty-eighth Exemplary Embodiment] A line-of-sight guiding degree calculation method of the seventeenth exemplary embodiment is characterized in that, in the line-of-sight guiding degree calculation method of any one of the twenty-third to the twenty-seventh exemplary embodiments,
in the line-of-sight guiding degree calculating, with the apexes of the projected part approximated in the projected part approximating device or the vicinities thereof set as guiding reference points, the line-of-sight guiding degrees are calculated with respect to the guiding reference points.

Consequently, an advantage equivalent to that in the line-of-sight guiding degree calculation system of the sixth exemplary embodiment is obtained.

[Twenty-ninth Exemplary Embodiment] A line-of-sight guiding degree calculation method of a twenty-ninth exemplary embodiment is characterized in that, in the line-of-sight guiding degree calculation method of any one of the twenty-third to the twenty-eighth exemplary embodiments,
the line-of-sight guiding degree calculating includes: calculating line-of-sight guiding directions, which are directions in which a line-of-sight is guided, with respect to the guiding reference points; and calculating line-of-sight guiding intensities, which are intensities at which a line-of-sight is guided, with respect to the guiding reference points.

Consequently, an advantage equivalent to that in the line-of-sight guiding degree calculation system of the seventh exemplary embodiment is obtained.

[Thirtieth Exemplary Embodiment] A line-of-sight guiding degree calculation method of a thirtieth exemplary embodiment is characterized in that, in the line-of-sight guiding degree calculation method of the twenty-ninth exemplary embodiment,
in the line-of-sight guiding direction calculating, in the case in which it is assumed that two auxiliary lines crossing the guiding reference points or the vicinities thereof are formed along an edge of an image passing the guiding reference points or the vicinities thereof, center directions of obtuse angles among angles formed by the imaginary auxiliary lines are calculated as the line-of-sight guiding directions.

Consequently, an advantage equivalent to that in the line-of-sight guiding degree calculation system of the eighth exemplary embodiment is obtained.

[Thirty-first Exemplary Embodiment] A line-of-sight guiding degree calculation method of a thirty-first exemplary embodiment is characterized in that, in the line-of-sight guiding degree calculation method of the twenty-ninth or the thirtieth exemplary embodiment,
in the line-of-sight guiding intensity calculating, distances from a center of gravity of an image object, a contour of which is formed including an edge of an image passing the guiding reference points or the vicinities thereof, to the guiding reference points are calculated as the line-of-sight guiding intensities.

Consequently, an advantage equivalent to that in the line-of-sight guiding degree calculation system of the ninth exemplary embodiment is obtained.

[Thirty-second Exemplary Embodiment] A line-of-sight guiding degree calculation method of a thirty-second exemplary embodiment is characterized in that, in the line-of-sight guiding degree calculation method of any one of the twenty-ninth to the thirty-first exemplary embodiments,
in the line-of-sight guiding intensity calculating, in the case in which it is assumed that two auxiliary lines crossing the guiding reference points or the vicinities thereof are formed along an edge of an image passing the guiding reference points or the vicinities thereof, distances from points where bisectors of acute angles among angles formed by the imaginary auxiliary lines cross a contour line of an image object, a contour of which is formed including the edge, to the guiding reference points are calculated as the line-of-sight guiding intensities.

Consequently, an advantage equivalent to that in the line-of-sight guiding degree calculation system of the tenth exemplary embodiment is obtained.

[Thirty-third Exemplary Embodiment] A line-of-sight guiding degree calculation method of a thirty-third exemplary embodiment is characterized in that, in the line-of-sight guiding degree calculation method of any one of the twenty-ninth to the thirty-second exemplary embodiments,
in the line-of-sight guiding intensity calculating, in the case in which it is assumed that two auxiliary lines crossing the guiding reference points or the vicinities thereof are formed along an edge of an image passing the guiding reference points or the vicinities thereof, angles formed by the imaginary auxiliary lines are calculated as the line-of-sight guiding intensities.

Consequently, an advantage equivalent to that in the line-of-sight guiding degree calculation system of the eleventh exemplary embodiment is obtained.

[Thirty-fourth Exemplary Embodiment] On the other hand, in order to attain the object, a line-of-sight guiding degree calculation system of a thirty-fourth exemplary embodiment is a system for calculating a degree, at which a line-of-sight is guided by an image, on the basis of image data constituting the image, characterized by including:
projected part approximating device that approximates a curved part including plural apexes included in the image to a projected part including apexes fewer than those of the curved part on the basis the image data; and a line-of-sight guiding degree calculating device that, with the apexes included in the projected part approximated by the projected part approximating device set as guiding reference points, calculates light-of-sight guiding degrees indicating degrees, at which a line-of-sight is guided, with respect to the guiding reference points.

With such a constitution, a curved part including plural apexes included in an image is approximated to a projected part including apexes fewer than the plural apexes by the projected part approximating device on the basis of image data, and with apexes included in the projected part approximated by the projected part approximating device set as guiding reference points, line-of-sight guiding degree are calculated by the line-of-sight guiding degree calculating device with respect to the guiding reference points.

A line-of-sight tends to be guided from the inside of an image object to a projected part. Therefore, by approximating a bent part to a projected part and setting apexes included in the projected part as guiding reference points, even if an image does not include a clear projected part, it can be calculated quantitatively and relatively appropriately in which direction the image tends to guide a line-of-sight. Thus, there is an advantage that a relatively appropriate eye flow can be obtained quantitatively compared with the related art technique. In addition, since it is unnecessary to separately provide a device such as an eye camera, an apparatus is never increased in size and large cost is never incurred, and there is also an advantage that reduction in size and reduction in cost of the apparatus can be realized compared with the related art technique. Moreover, since a line-of-sight guiding degree is not calculated by a method of learning, there is also an advantage that an appropriate eye flow can be obtained relatively surely.

Here, the curved part including plural apexes includes a shape like the ria coast. The same holds true for a line-of-sight guiding degree calculation program of a forty-fifth exemplary embodiment and a line-of-sight guiding degree calculation method of a fifty-sixth exemplary embodiment to be described below.

In addition, the system may be realized as a single apparatus, terminal, or other device or may be realized as a network system in which plural apparatuses, terminals, or other devices are connected so as to be capable of communicating with each other. In the latter case, respective components may belong to any one of the plural devices or the like as long as the components are connected so as to be capable of communicating with each other.

[Thirty-fifth Exemplary Embodiment] A line-of-sight guiding degree calculation system of a thirty-fifth exemplary embodiment is characterized in that, in the line-of-sight guiding degree calculation system of the thirty-fourth exemplary embodiment,
the projected part approximating device subjects the curved part to polygon approximation.

With such a constitution, a curved part is subjected to polygon approximation by the projected part approximating device.

Consequently, since the curved part can be approximated to a projected part of a relatively similar shape, there is an advantage that, even if an image does not include a clear projected part, it can be calculated more appropriately in which direction the image tends to guide a line-of-sight.

[Thirty-sixth Exemplary Embodiment] A line-of-sight guiding degree calculation system of a thirty-sixth exemplary embodiment is characterized in that, in the line-of-sight guiding degree calculation system of the thirty-fourth or the thirty-fifth exemplary embodiment,
the projected part approximating device sets one or more auxiliary points between both end points of the curved part and on an edge of the curved part and approximates a shape, which is formed by connecting points adjacent to each other on the edge among both the end points of the curved part and the auxiliary points with lines, as the projected part.

With such a constitution, one or more auxiliary points are set between both end points of a curved part and on an edge of the curved part by the projected part approximating device, and a shape, which is formed by connecting points adjacent to each other on the edge among both the end points of the curved part and the auxiliary points with lines, is approximated as a projected part.

Consequently, since the curved part can be approximated to a projected part of a relatively similar shape, there is an advantage that, even if an image does not include a clear projected part, it can be calculated more appropriately in which direction the image tends to guide a line-of-sight.

[Thirty-seventh Exemplary Embodiment] A line-of-sight guiding degree calculation system of a thirty-seventh exemplary embodiment is characterized in that, in the line-of-sight guiding degree calculation system of the thirty-fifth or the thirty-sixth exemplary embodiments,
the projected part approximating device includes: a first auxiliary point setting device that sets the auxiliary points in positions where distances from a straight line connecting both the end points of the curved part to the edge are maximized; and a second auxiliary point setting device that sets the auxiliary points in positions where distances from straight lines connecting points adjacent to each other on the edge among both the end points of the curved part and the auxiliary points to the edge are maximized, and approximates a polygon, which is formed by connecting points adjacent to each other on the edge among both the end points of the curved part and the auxiliary points with straight lines, as the projected part.

With such a constitution, auxiliary points are set in positions, where distances from a straight line connecting both end points of a curved part to an edge are maximized, by the first auxiliary point setting device. In addition, the auxiliary points are set in positions, where distances from straight lines connecting points adjacent to each other on the edge among both the end points of the curved part and the auxiliary points are maximized, by the second auxiliary point setting device. When the auxiliary points are set in this way, a polygon, which is formed by connecting points adjacent to each other on the edge among both the end points of the curved part and the auxiliary points with straight lines, is approximated as a projected part by the projected part approximating device.

Consequently, since the curved part can be approximated to a projected part of a relatively similar shape and can also be approximated as a polygon with which a line-of-sight guiding degree is easily obtained, there is an advantage that, even if an image does not include a clear projected part, it can be calculated more appropriately in which direction the image tends to guide a line-of-sight.

[Thirty-eighth Exemplary Embodiment] A line-of-sight guiding degree calculation system of a thirty-eighth exemplary embodiment is characterized in that, in the line-of-sight guiding degree calculation system of the thirty-seventh exemplary embodiment,
the projected part approximating device performs the setting by the second auxiliary point setting device repeatedly until a distance between the curved part and the polygon is reduced to a predetermined distance or less.

With such a constitution, the setting by the second auxiliary point setting device is performed repeatedly by the projected part approximating device until a distance between a curved part and a polygon is reduced to a predetermined distance or less, and a polygon, which is formed by connecting points adjacent to each other on an edge among both end points of the curved part and auxiliary points with straight lines, is approximated as a projected part.

Consequently, since the curved part can be approximated to a projected part of a similar shape, there is an advantage that, even if an image does not include a clear projected part, it can be calculated more appropriately in which direction the image tends to guide a line-of-sight.

Here, the distance refers to a distance from straight lines connecting the points adjacent to each other on the edge among both the end points of the curved part and the auxiliary points to the auxiliary points set in positions where a distance to the edge is maximized.

[Thirty-ninth Exemplary Embodiment] A line-of-sight guiding degree calculation system of a thirty-ninth exemplary embodiment is characterized in that, in the line-of-sight guiding degree calculation system of any one of the thirty-fourth to the thirty-eighth exemplary embodiments,
the line-of-sight guiding degree calculating device calculates, with apexes of the projected part approximated by the projected part approximating device or vicinities thereof set as guiding reference points, the line-of-sight guiding degrees with respect to the guiding reference points.

With such a constitution, with apexes of a projected part approximated by the projected part approximating device or vicinities thereof set as guiding reference points, the line-of-sight guiding degrees are calculated with respect to the guiding reference points.

In the case in which an image object having a projected part is included in an image, a line-of-sight tends to be guided from the inside of the image object toward the projected part. Therefore, by setting apexes of the projected part and vicinities thereof as guiding reference points, there is an advantage that it can be calculated more appropriately in which direction an image tends to guide a line-of-sight.

From a viewpoint of obtaining an appropriate eye flow, it is preferable to set apexes of a projected part as guiding reference points. However, in the case in which it is difficult to specify apexes of a projected part or in the case in which an eye flow is obtained at low accuracy from a viewpoint of reduction in an amount of calculation or the like, vicinities of the apexes of the projected part may be set as guiding reference points in a range in which an inappropriate eye flow is not obtained.

[Fortieth Exemplary Embodiment] A line-of-sight guiding degree calculation system of a fortieth exemplary embodiment is characterized in that, in the line-of-sight guiding degree calculation system of any one of the thirty-fourth to the thirty-ninth exemplary embodiments,
the line-of-sight guiding degree calculating device includes: a line-of-sight guiding direction calculating device that calculates line-of-sight guiding directions, which are directions in which a line-of-sight is guided, with respect to the guiding reference points; and a line-of-sight guiding intensity calculating device that calculates line-of-sight guiding intensities, which are intensities at which a line-of-sight is guided, with respect to the guiding reference points.

With such a constitution, line-of-sight guiding directions are calculated with respect to guiding reference points by the line-of-sight guiding direction calculating device, and line-of-sight guiding intensities are calculated with respect to the guiding reference points by the line-of-sight guiding intensity calculating device. In other words, it is possible to calculate the line-of-sight guiding directions and the line-of-sight guiding intensities as line-of-sight guiding degrees.

In the case in which an image object having a projected part is included in an image, a line-of-sight tends to be guided at a predetermined magnitude in a predetermined direction with points near apexes of the projected part as references. Therefore, by calculating line-of-sight guiding directions and line-of-sight guiding intensities as line-of-sight guiding degrees, there is an advantage that it can be calculated more appropriately in which direction the image tends to guide a line-of-sight.

[Forty-first Exemplary Embodiment] A line-of-sight guiding degree calculation system of a forty-first exemplary embodiment is characterized in that, in the line-of-sight guiding degree calculation system of the fortieth exemplary embodiment,
in the case in which it is assumed that two auxiliary lines crossing the guiding reference points or the vicinities thereof are formed along an edge of an image passing the guiding reference points or the vicinities thereof, the line-of-sight guiding direction calculating device calculates center directions of obtuse angles among angles formed by the imaginary auxiliary lines as the line-of-sight guiding directions.

With such a constitution, in the case in which it is assumed that two auxiliary lines crossing the guiding reference points or the vicinities thereof are formed along an edge of an image passing the guiding reference points or the vicinities thereof, center directions of obtuse angles among angles formed by the imaginary auxiliary lines are calculated as the line-of-sight guiding directions by the line-of-sight guiding direction calculating device.

Consequently, since directions from the inside of an image object toward apexes of a projected part can be calculated as line-of-sight guiding directions, there is an advantage that it can be calculated more appropriately in which direction an image tends to guide a line-of-sight.

Here, assuming that imaginary auxiliary lines crossing guiding reference points or vicinities thereof are formed along an edge of an image, the line-of-sight guiding direction calculating device calculates line-of-sight guiding directions. From a viewpoint of obtaining an appropriate eye flow, it is preferable to calculate line-of-sight guiding directions assuming that imaginary auxiliary lines crossing guiding reference points are formed along an edge of an image. However, in the case in which it is difficult to form imaginary auxiliary lines crossing guiding reference points in terms of calculation or in the case in which an eye flow is obtained at low accuracy from a viewpoint of reduction in an amount of calculation or the like, line-of-sight guiding directions may be calculated assuming that imaginary auxiliary lines crossing vicinities of guiding reference points are formed along an edge of an image in a range in which an inappropriate eye flow is not obtained.

[Forth-second Exemplary Embodiment] A line-of-sight guiding degree calculation system of a forty-second exemplary embodiment is characterized in that, in the line-of-sight guiding degree calculation system of the fortieth or the forty-first exemplary embodiment,
the line-of-sight guiding degree calculating device calculates distances from a center of gravity of an image object, a contour of which is formed including an edge of an image passing the guiding reference points or the vicinities thereof, to the guiding reference points as the line-of-sight guiding intensities.

With such a constitution, distances from a center of gravity of an image object, a contour of which is formed including an edge of an image passing guiding reference points or vicinities thereof, to the guiding reference points are calculated as line-of-sight guiding intensities by the line-of-sight guiding degree calculating device.

As a sharpness degree of a projected part of an image object is larger, a line-of-sight tends to be guided more to the projected part. In addition, distances from a center of gravity of the image object to guiding reference points increase as the sharpness degree is larger. Therefore, since line-of-sight guiding intensities corresponding to magnitudes of the sharpness degree of the projected part of the image object can be calculated, there is an advantage that it can be calculated more appropriately in which direction an image guides a line-of-sight.

Here, the image object refers to an area having a contour in an image. This area may be a closed area or an open area. The same holds true for line-of-sight guiding degree calculation systems of forth-third and forth-fourth exemplary embodiments, to be described below.

[Forth-third Exemplary Embodiment] A line-of-sight guiding degree calculation system of a forty-third exemplary embodiment is characterized in that, in the line-of-sight guiding degree calculation system of any one of the fortieth to the forty-second exemplary embodiments,
in the case in which it is assumed that two auxiliary lines crossing the guiding reference points or the vicinities thereof are formed along an edge of an image passing the guiding reference points or the vicinities thereof, the line-of-sight guiding intensity calculating device calculates distances from points where bisectors of acute angles among angles formed by the imaginary auxiliary lines cross a contour line of an image object, a contour of which is formed including the edge, to the guiding reference points as the line-of-sight guiding intensities.

With such a constitution, in the case in which it is assumed that two auxiliary lines crossing guiding reference points or vicinities thereof are formed along an edge of an image passing the guiding reference points or the vicinities thereof, distances from points where bisectors of acute angles among angles formed by the imaginary auxiliary lines cross a contour line of an image object, a contour of which is formed including the edge, to the guiding reference points are calculated as line-of-sight guiding intensities by the line-of-sight guiding intensity calculating device.

As a sharpness degree of a projected part of an image object is larger, a line-of-sight tends to be guided more to the projected part. In addition, distances from points where bisectors of acute angles among angles formed by imaginary auxiliary lines cross a contour line of an image object to guiding reference points increase as the sharpness degree is larger. Therefore, since line-of-sight guiding intensities corresponding to magnitudes of the sharpness degree of the projected part of the image object can be calculated, there is an advantage that it can be calculated more appropriately in which direction an image tends to guide a line-of-sight.

Here, assuming that imaginary auxiliary lines crossing guiding reference points or vicinities thereof are formed along an edge of an image, the line-of-sight guiding intensity calculating device calculates line-of-sight guiding intensities. From a viewpoint of obtaining an appropriate eye flow, it is preferable to calculate line-of-sight guiding intensities assuming that imaginary auxiliary lines crossing guiding reference points are formed along an edge of an image. However, in the case in which it is difficult to form imaginary auxiliary lines crossing guiding reference points in terms of calculation or in the case in which an eye flow is obtained at low accuracy from a viewpoint of reduction in an amount of calculation or the like, line-of-sight guiding intensities may be calculated assuming that imaginary auxiliary lines crossing vicinities of guiding reference points are formed along an edge of an image in a range in which an inappropriate eye flow is not obtained. The same holds true for a line-of-sight guiding degree calculation system of a forty-fourth exemplary embodiment to be described below.

[Forty-fourth Exemplary Embodiment] A line-of-sight guiding degree calculation system of a forty-fourth exemplary embodiment is characterized in that, in the line-of-sight guiding degree calculation system of any one of the fortieth to the forty-third exemplary embodiments,
in the case in which it is assumed that two auxiliary lines crossing the guiding reference points or the vicinities thereof are formed along an edge of an image passing the guiding reference points or the vicinities thereof, the line-of-sight guiding intensity calculating device calculates angles formed by the imaginary auxiliary lines as the line-of-sight guiding intensities.

With such a constitution, in the case in which it is assumed that two auxiliary lines crossing guiding reference points or vicinities thereof are formed along an edge of an image passing the guiding reference points or the vicinities thereof, angles formed by the imaginary auxiliary lines are calculated as line-of-sight guiding intensities by the line-of-sight guiding intensity calculating device.

As a sharpness degree of a projected part of an image object is larger, a line-of-sight tends to be guided more to the projected part. In addition, the angles formed by the imaginary auxiliary lines are smaller as the sharpness degree is larger. Therefore, since line-of-sight guiding intensities corresponding to magnitudes of the sharpness degree of the projected part of the image object can be calculated, there is an advantage that it can be calculated more appropriately in which direction an image tends to guide a line-of-sight.

[Forty-fifth Exemplary Embodiment] On the other hand, in order to attain the object, a line-of-sight guiding degree calculation program of a forty-fifth exemplary embodiment is a line-of-sight guiding degree calculation program to calculate degrees, at which a line-of-sight is guided by an image, on the basis of image data constituting the image, characterized by including:
a program for causing a computer to execute processing including: approximating a curved part including plural apexes included in the image to a projected part including apexes fewer than those of the curved part on the basis of the image data; and, with the apexes included in the projected part approximated in the projected part approximating set as guiding reference points, calculating line-of-sight guiding degrees indicating degrees, at which a line-of-sight is guided, with respect to the guiding reference points.

With such a constitution, when the program is read by the computer, and the computer executes the processing in accordance with the read program, an action and an advantage equivalent to those in the line-of-sight guiding degree calculation system of the thirty-fourth exemplary embodiment are obtained.

[Forty-sixth Exemplary Embodiment] A line-of-sight guiding degree calculation program of a forty-sixth exemplary embodiment is characterized in that, in the line-of-sight guiding degree calculation program of the forty-fifth exemplary embodiment,
the curved part is subjected to polygon approximation in the projected part approximating.

With such a constitution, when the program is read by the computer, and the computer executes the processing in accordance with the read program, an action and an advantage equivalent to those in the line-of-sight guiding degree calculation system of the thirty-fifth exemplary embodiment are obtained.

[Forty-seventh Exemplary Embodiment] A line-of-sight guiding degree calculation program of a forty-seventh exemplary embodiment is characterized in that, in the line-of-sight guiding degree calculation program of the forty-fifth or the forty-sixth exemplary embodiment,
in the projected part approximating, one or more auxiliary points are set between both end points of the curved part and on an edge of the curved part, and a shape, which is formed by connecting points adjacent to each other on the edge among both the end points of the curved part and the auxiliary points with lines, is approximated as the projected part.

With such a constitution, when the program is read by the computer, and the computer executes the processing in accordance with the read program, an action and an advantage equivalent to those in the line-of-sight guiding degree calculation system of the thirty-sixth exemplary embodiment are obtained.

[Forty-eighth Exemplary Embodiment] A line-of-sight guiding degree calculation program of a forty-eighth exemplary embodiment is characterized in that, in the line-of-sight guiding degree calculation program of the forty-sixth or the forty-seventh exemplary embodiment,
the projected part approximating includes: a first auxiliary point setting of setting the auxiliary points in positions where distance from a straight line connecting both the end points of the curved part to the edge are maximized; and a second auxiliary point setting of setting the auxiliary points in positions where straight lines connecting points adjacent to each other on the edge among both the end points of the curved part and the auxiliary points to the edge is maximized, and a polygon, which is obtained by connecting the points adjacent to each other on the edge among both the end points of the curved part and the auxiliary points with straight lines, is approximated as the projected part.

With such a constitution, when the program is read by the computer, and the computer executes the processing in accordance with the read program, an action and an advantage equivalent to those in the line-of-sight guiding degree calculation system of the thirty-seventh exemplary embodiment are obtained.

[Forty-ninth Exemplary Embodiment] A line-of-sight guiding degree calculation program of a forty-ninth exemplary embodiment is characterized in that, in the line-of-sight guiding degree calculation program of the forty-eighth exemplary embodiment,
in the projected part approximating, the setting by the second auxiliary point setting device is performed repeatedly until a distance between the curved part and the polygon is reduced to a predetermined distance or less.

With such a constitution, when the program is read by the computer, and the computer executes the processing in accordance with the read program, an action and an advantage equivalent to those in the line-of-sight guiding degree calculation system of the thirty-eighth exemplary embodiment are obtained.

[Fiftieth Exemplary Embodiment] A line-of-sight guiding degree calculation program of a fiftieth exemplary embodiment is characterized in that, in the line-of-sight guiding degree calculation program of any one of the fifty-fifth to the fifty-ninth exemplary embodiments,
in the line-of-sight guiding degree calculating, with the apexes of the projected part approximated by the projected part approximating or the vicinities thereof set as guiding reference points, the line-of-sight guiding degrees are calculated with respect to the guiding reference points.

With such a constitution, when the program is read by the computer, and the computer executes the processing in accordance with the read program, an action and an advantage equivalent to those in the line-of-sight guiding degree calculation system of the thirty-ninth exemplary embodiment are obtained.

[Fifty-first Exemplary Embodiment] A line-of-sight guiding degree calculation program of a fifty-first exemplary embodiment is characterized in that, in the line-of-sight guiding degree calculation program of any one of the forty-fifth to the fiftieth exemplary embodiment,
the line-of-sight guiding degree calculating includes: calculating line-of-sight guiding directions, which are directions in which a line-of-sight is guided, with respect to the guiding reference points; and calculating line-of-sight guiding intensities, which are intensities at which a line-of-sight is guided, with respect to the guiding reference points.

With such a constitution, when the program is read by the computer, and the computer executes the processing in accordance with the read program, an action and an advantage equivalent to those in the line-of-sight guiding degree calculation system of the fortieth invention are obtained.

[Fifty-second Exemplary Embodiment] A line-of-sight guiding degree calculation program of a fifty-second exemplary embodiment is characterized in that, in the line-of-sight guiding degree calculation program of the fifty-first exemplary embodiment,
in the line-of-sight guiding direction calculating, in the case in which it is assumed that two auxiliary lines crossing the guiding reference points or the vicinities thereof are formed along an edge of an image passing the guiding reference points or the vicinities thereof, center directions of obtuse angles among angles formed by the imaginary auxiliary lines are calculated as the line-of-sight guiding directions.

With such a constitution, when the program is read by the computer, and the computer executes the processing in accordance with the read program, an action and an advantage equivalent to those in the line-of-sight guiding degree calculation system of the forty-first exemplary embodiment are obtained.

[Fifty-third Exemplary Embodiment] A line-of-sight guiding degree calculation program of a fifty-third exemplary embodiment is characterized in that, in the line-of-sight guiding degree calculation program of the fifty-first or the fifty-second exemplary embodiment,
in the line-of-sight guiding intensity calculating, distances from a center of gravity of an image object, a contour of which is formed including an edge of an image passing the guiding reference points or the vicinities thereof, to the guiding reference points are calculated as the line-of-sight guiding intensities.

With such a constitution, when the program is read by the computer, and the computer executes the processing in accordance with the read program, an action and an advantage equivalent to those in the line-of-sight guiding degree calculation system of the forty-second exemplary embodiment are obtained.

[Fifty-fourth Exemplary Embodiment] A line-of-sight guiding degree calculation program of a fifty-fourth exemplary embodiment is characterized in that, in the line-of-sight guiding degree calculation program of any one of the fifty-first to the fifty-third exemplary embodiments,
in the line-of-sight guiding intensity calculating, in the case in which it is assumed that two auxiliary lines crossing the guiding reference points or the vicinities thereof are formed along an edge of an image passing the guiding reference points or the vicinities thereof, distances from points where bisectors of acute angles among angles formed by the imaginary auxiliary lines cross a contour line of an image object, a contour of which is formed including the edge, to the guiding reference points are calculated as the line-of-sight guiding intensities.

With such a constitution, when the program is read by the computer, and the computer executes the processing in accordance with the read program, an action and an advantage equivalent to those in the line-of-sight guiding degree calculation system of the forty-second exemplary embodiment are obtained.

[Fifty-fifth Exemplary Embodiment] A line-of-sight guiding degree calculation program of a fifty-fifth exemplary embodiment is characterized in that, in the line-of-sight guiding degree calculation program of any one of the fifty-first to the fifty-fourth exemplary embodiments,
in the line-of-sight guiding intensity calculating, in the case in which it is assumed that two auxiliary lines crossing the guiding reference points or the vicinities thereof are formed along an edge of an image passing the guiding reference points or the vicinities thereof, angles formed by the imaginary auxiliary lines are calculated as the line-of-sight guiding intensities.

With such a constitution, when the program is read by the computer, and the computer executes the processing in accordance with the read program, an action and an advantage equivalent to those in the line-of-sight guiding degree calculation system of the forty-third exemplary embodiment are obtained.

[Fifty-sixth Exemplary Embodiment] On the other hand, in order to attain the object, a line-of-sight guiding degree calculation method of a fifty-sixth exemplary embodiment is a line-of-sight guiding degree calculation method to calculate degrees, at which a line-of-sight is guided by an image, on the basis of image data constituting the image, characterized by including:
approximating a curved part including plural apexes included in the image to a projected part including apexes fewer than those of the curved part on the basis of the image data; and, with the apexes included in the projected part approximated in the projected part approximating set as guiding reference points, calculating line-of-sight guiding degrees indicating degrees, at which a line-of-sight is guided, with respect to the guiding reference points.

Consequently, an advantage equivalent to that in the line-of-sight guiding degree calculation system of the thirty-fourth exemplary embodiment is obtained.

[Fifty-seventh Exemplary Embodiment] A line-of-sight guiding degree calculation method of a fifty-seventh exemplary embodiment is characterized in that, in the line-of-sight guiding degree calculation method of the fifty-sixth exemplary embodiment,
in the projected part approximating, the curved part is subjected to polygon approximation.

Consequently, an advantage equivalent to that in the line-of-sight guiding degree calculation system of the thirty-fifth exemplary embodiment is obtained.

[Fifth-eighth Exemplary Embodiment] A line-of-sight guiding degree calculation method of a fifty-eighth exemplary embodiment is the line-of-sight guiding degree calculation method of the fifty-sixth or the fifty-seventh exemplary embodiment,
in the projected part approximating, one or more auxiliary points are set between both end points of the curved part and on an edge of the curved part, and a shape, which is formed by connecting points adjacent to each other on the edge among both the end points of the curved part and the auxiliary points with lines, is approximated as the projected part.

Consequently, an advantage equivalent to that in the line-of-sight guiding degree calculation system of the thirty-sixth exemplary embodiment is obtained.

[Fifty-ninth Exemplary Embodiment] A line-of-sight guiding degree calculation method of a fifty-ninth exemplary embodiment is characterized in that, in the line-of-sight guiding degree calculation method of the fifty-seventh or the fifty-eighth exemplary embodiment,
the projected part approximating includes: setting the auxiliary points in positions where distances from a straight line connecting both the end points of the curved part to the edge are maximized; and setting the auxiliary points in positions where distances from straight lines connecting points adjacent to each other on the edge among both the end points of the curved part and the auxiliary points to the edge are maximized, and a polygon, which is obtained by connecting the points adjacent to each other on the edge among both the end points of the curved part and the auxiliary points with straight lines, is approximated as the projected part.

Consequently, an advantage equivalent to that in the line-of-sight guiding degree calculation system of the thirty-seventh exemplary embodiment is obtained.

[Sixtieth Exemplary Embodiment] A line-of-sight guiding degree calculation method of a sixtieth exemplary embodiment is characterized in that, in the line-of-sight guiding degree calculation method of the fifty-ninth invention,
in the projected part approximating, the setting by the second auxiliary point setting device is performed repeatedly until a distance between the curved part and the polygon is reduced to a predetermined distance or less.

Consequently, an advantage equivalent to that in the line-of-sight guiding degree calculation system of the thirty-eighth exemplary embodiment is obtained.

[Sixty-first Exemplary Embodiment] A line-of-sight guiding degree calculation method of a sixty-first exemplary embodiment is characterized in that, in the line-of-sight guiding degree calculation method of any one of the fifty-sixth to the sixtieth exemplary embodiments,
in the line-of-sight guiding degree calculating, with the apexes of the projected part approximated by the projected part approximating or the vicinities thereof set as guiding reference points, the line-of-sight guiding degrees are calculated with respect to the guiding reference points.

Consequently, an advantage equivalent to that in the line-of-sight guiding degree calculation system of the thirty-ninth exemplary embodiment is obtained.

[Sixty-second Exemplary Embodiment] A line-of-sight guiding degree calculation method of a sixty-second exemplary embodiment is characterized in that, in the line-of-sight guiding degree calculation method of any one of the fifty-sixth to the sixty-first exemplary embodiments,
the line-of-sight guiding degree calculating includes: calculating line-of-sight guiding directions, which are directions in which a line-of-sight is guided, with respect to the guiding reference points; and calculating line-of-sight guiding intensities, which are intensities at which a line-of-sight is guided, with respect to the guiding reference points.

Consequently, an advantage equivalent to that in the line-of-sight guiding degree calculation system of the fortieth exemplary embodiment is obtained.

[Sixty-third Exemplary Embodiment] A line-of-sight guiding degree calculation method of a sixty-third exemplary embodiment is characterized in that, in the line-of-sight guiding degree calculation method of the sixty-second exemplary embodiment,
in the line-of-sight guiding direction calculating, in the case in which it is assumed that two auxiliary lines crossing the guiding reference points or the vicinities thereof are formed along an edge of an image passing the guiding reference points or the vicinities thereof, center directions of obtuse angles among angles formed by the imaginary auxiliary lines are calculated as the line-of-sight guiding directions.

Consequently, an advantage equivalent to that in the line-of-sight guiding degree calculation system of the forth-first exemplary embodiment is obtained.

[Sixty-fourth Exemplary Embodiment] A line-of-sight guiding degree calculation method of a sixty-fourth exemplary embodiment is characterized in that, in the line-of-sight guiding degree calculation method of the sixty-second or the sixty-third exemplary embodiment,
in the line-of-sight guiding intensity calculating, distances from a center of gravity of an image object, a contour of which is formed including an edge of an image passing the guiding reference points or the vicinities thereof, to the guiding reference points are calculated as the line-of-sight guiding intensities.

Consequently, an advantage equivalent to that in the line-of-sight guiding degree calculation system of the forty-second exemplary embodiment is obtained.

[Sixty-fifth Exemplary Embodiment] A line-of-sight guiding degree calculation method of a sixty-fifth exemplary embodiment is characterized in that, in the line-of-sight guiding degree calculation method of any one of the sixty-second to the sixty-fourth exemplary embodiments,
in the line-of-sight guiding intensity calculating, in the case in which it is assumed that two auxiliary lines crossing the guiding reference points or the vicinities thereof are formed along an edge of an image passing the guiding reference points or the vicinities thereof, distances from points where bisectors of acute angles among angles formed by the imaginary auxiliary lines cross a contour line of an image object, a contour of which is formed including the edge, to the guiding reference points are calculated as the line-of-sight guiding intensities.

Consequently, an advantage equivalent to that in the line-of-sight guiding degree calculation system of the forth-third exemplary embodiment is obtained.

[Sixty-sixth Exemplary Embodiment] A line-of-sight guiding degree calculation method of a sixty-sixth exemplary embodiment is characterized in that, in the line-of-sight guiding degree calculation method of any one of the sixty-second to the sixty-fifth exemplary embodiments,
in the line-of-sight guiding intensity calculating, in the case in which it is assumed that two auxiliary lines crossing the guiding reference points or the vicinities thereof are formed along an edge of an image passing the guiding reference points or the vicinities thereof, angles formed by the imaginary auxiliary lines are calculated as the line-of-sight guiding intensities.

Consequently, an advantage equivalent to that in the line-of-sight guiding degree calculation system of the forty-fourth exemplary embodiment is obtained.

[Sixty-seventh Exemplary Embodiment] In order to attain the object, a line-of-sight guiding degree calculation system of a sixty-seventh exemplary embodiment is a system for calculating degrees, at which an image guides a line-of-sight, on the basis of image data, characterized by including:
a projected part approximating device that approximates a bent part included in the image to a projected part on the basis the image data; a guiding reference point detecting device that detects guiding reference points to be references to guide a line-of-sight out of the projected part approximated by the projected part approximating device; and a line-of-sight guiding degree calculating device that calculates line-of-sight guiding degrees indicating degrees, at which a line-of-sight is guided, with respect to the guiding reference points detected by the guiding reference point detecting device.

With such a constitution, a bent part included in an image is approximated to a projected part by the projected part approximating device on the basis of image data, guiding reference points are detected out of the approximated projected part by the guiding reference point detecting device, and line-of-sight guiding degrees are calculated by the line-of-sight guiding degree calculating device with respect to the guiding reference points.

A line-of-sight tends to be guided from the inside of an image object to a projected part. Therefore, by approximating a bent part to a projected part and detecting guiding reference points out of the projected part, even if an image does not include a clear projected part, it can be calculated quantitatively and relatively appropriately in which direction the image tends to guide a line-of-sight. Thus, there is an advantage that a relatively appropriate eye flow can be obtained quantitatively compared with the related art technique. In addition, since it is unnecessary to separately provide a device such as an eye camera, an apparatus is never increased in size and large cost is never incurred, and there is also an advantage that reduction in size and reduction in cost of the apparatus can be realized compared with the related art technique. Moreover, since a line-of-sight guiding degree is not calculated by a method of learning, there is also an advantage that an appropriate eye flow can be obtained relatively surely.

Here, the bent part includes a curved line part and a shape such as the ria coast. The same holds true for a line-of-sight guiding degree calculation program of a seventy-eighth exemplary embodiment and a line-of-sight guiding degree calculation method of a seventy-ninth exemplary embodiment to be described below.

In addition, the system may be realized as a single apparatus, terminal, or other device or may be realized as a network system in which plural apparatuses, terminals, or other devices are connected so as to be capable of communicating with each other. In the latter case, respective components may belong to any one of the plural devices or the like as long as the components are connected so as to be capable of communicating with each other.

[Sixty-eighth Exemplary Embodiment] A line-of-sight guiding degree calculation system of a sixty-eighth exemplary embodiment is characterized in that, in the line-of-sight guiding degree calculation system of a sixty-seventh exemplary embodiment,
the projected part approximating device subjects the bent part to polygon approximation.

With such a constitution, a bent part is subjected to polygon approximation by the projected part approximating device.

Consequently, since the bent part can be approximated to a projected part of a relatively similar shape, there is an advantage that, even if an image does not include a clear projected part, it can be calculated more appropriately in which direction the image tends to guide a line-of-sight.

[Sixty-ninth Exemplary Embodiment] A line-of-sight guiding degree calculation system of a sixty-ninth exemplary embodiment is characterized in that, in the line-of-sight guiding degree calculation system of the sixty-seventh or the sixty-eighth exemplary embodiment,
the projected part approximating device sets one or more auxiliary points on an edge of the bent part and between both end points of the bent part and approximates a shape, which is formed by connecting points adjacent to each other on the edge among both the end points of the bent part and the auxiliary points with lines, as the projected part.

With such a constitution, one or plural auxiliary points are set on an edge of a bent part and between both end points of the bent part by the projected part approximating device, and a shape, which is formed by connecting points adjacent to each other on the edge among both the end points of the bent part and the auxiliary points with lines, is approximated as a projected part.

Consequently, since the bent part can be approximated to a projected part of a relatively similar shape, there is an advantage that, even if an image does not include a clear projected part, it can be calculated more appropriately in which direction the image tends to guide a line-of-sight.

[Seventieth Exemplary Embodiment] A line-of-sight guiding degree calculation system of a seventieth exemplary embodiment is characterized in that, in the line-of-sight guiding degree calculation system of the sixty-eighth or the sixty-ninth exemplary embodiment,
the projected part approximating device includes: a first auxiliary point setting device that sets the auxiliary points in positions where distances from a straight line connecting both the end points of the bent part to the edge are maximized; and a second auxiliary point setting device that sets the auxiliary points in positions where distances from straight lines connecting points adjacent to each other on the edge among both the end points of the bent part and the auxiliary points to the edge are maximized, and approximates a polygon, which is formed by connecting points adjacent to each other on the edge among both the end points of the bent part and the auxiliary points with straight lines, as the projected part.

With such a constitution, auxiliary points are set in positions, where distances from a straight line connecting both end points of a bent part to an edge are maximized, by the first auxiliary point setting device. In addition, the auxiliary points are set in positions, where distances from straight lines connecting points adjacent to each other on the edge among both the end points of the bent part and the auxiliary points are maximized, by the second auxiliary point setting device. When the auxiliary points are set in this way, a polygon, which is formed by connecting points adjacent to each other on the edge among both the end points of the bent part and the auxiliary points with straight lines, is approximated as a projected part by the projected part approximating device.

Consequently, since the bent part can be approximated to a projected part of a relatively similar shape and can also be approximated as a polygon with which a line-of-sight guiding degree is easily obtained, there is an advantage that, even if an image does not include a clear projected part, it can be calculated more appropriately in which direction the image tends to guide a line-of-sight.

[Seventy-first Exemplary Embodiment] A line-of-sight guiding degree calculation system of a seventy-first exemplary embodiment is characterized in that, in the line-of-sight guiding degree calculation system of the seventieth exemplary embodiment,
the projected part approximating device performs the setting by the second auxiliary point setting device repeatedly until an error between the bent part and the polygon is reduced to a predetermined error or less.

With such a constitution, the setting by the second auxiliary point setting device is performed repeatedly by the projected part approximating device until an error between a bent part and a polygon is reduced to a predetermined error or less, and a polygon, which is formed by connecting points adjacent to each other on an edge among both end points of the bent part and auxiliary points with straight lines, is approximated as a projected part.

Consequently, since the bent part can be approximated to a projected part of a similar shape, there is an advantage that, even if an image does not include a clear projected part, it can be calculated more appropriately in which direction the image tends to guide a line-of-sight.

Here, for example, a difference between an area of an image object and an area of a polygon is calculated as an error.

[Seventy-second Exemplary Embodiment] A line-of-sight guiding degree calculation system of a seventy-second exemplary embodiment is characterized in that, in the line-of-sight guiding degree calculation system of any one of the sixty-seventh to the seventy-first exemplary embodiments,

the guiding reference point detecting device detects apexes of the projected part approximated by the projected part approximating device or vicinities thereof as the guiding reference points.

With such a constitution, apexes of an approximated projected part or vicinities thereof are detected as guiding reference points by the guiding reference point detecting device.

In the case in which an image object having a projected part is included in an image, a line-of-sight tends to be guided from the inside of the image object toward the projected part. Therefore, by detecting apexes of the projected part as guiding reference points, there is an advantage that it can be calculated more appropriately in which direction an image tends to guide a line-of-sight.

Here, the guiding reference point detecting device detects apexes of a projected part or vicinities thereof as guiding reference points. From a viewpoint of obtaining an appropriate eye flow, it is preferable to detect apexes of a projected part as guiding reference points. However, in the case in which it is difficult to specify apexes of a projected part or in the case in which an eye flow is obtained at low accuracy from a viewpoint of reduction in an amount of calculation or the like, vicinities of the apexes of the projected part may be set as guiding reference points in a range in which an inappropriate eye flow is not obtained.

[Seventy-third Exemplary Embodiment] A line-of-sight guiding degree calculation system of a seventy-third exemplary embodiment is characterized in that, in the line-of-sight guiding degree calculation system of any one of the sixty-seventh to the seventy-second exemplary embodiments,
the line-of-sight guiding degree calculating device includes: a line-of-sight guiding direction calculating device that calculates line-of-sight guiding directions, which are directions in which a line-of-sight is guided, with respect to the guiding reference points detected by the guiding reference point detecting device; and a line-of-sight guiding intensity calculating device that calculates line-of-sight guiding intensities indicating intensities at which a line-of-sight is guided with respect to the guiding reference points detected by the guiding reference point detecting device, and calculates the line-of-sight guiding directions and the line-of-sight guiding intensities as the line-of-sight guiding degrees.

With such a constitution, line-of-sight guiding directions are calculated with respect to detected guiding reference points by the line-of-sight guiding direction calculating device, and line-of-sight guiding intensities are calculated with respect to the detected guiding reference points by the line-of-sight guiding intensity calculating device. Then, line-of-sight guiding directions and line-of-sight guiding intensities are calculated as line-of-sight guiding degrees.

In the case in which an image object having a projected part is included in an image, a line-of-sight tends to be guided at a predetermined magnitude in a predetermined direction with points near apexes of the projected part as references. Therefore, by calculating line-of-sight guiding directions and line-of-sight guiding intensities as line-of-sight guiding degrees, there is an advantage that it can be calculated more appropriately in which direction the image tends to guide a line-of-sight.

[Seventy-fourth Exemplary Embodiment] A line-of-sight guiding degree calculation system of a seventy-fourth exemplary embodiment is characterized in that, in the line-of-sight guiding degree calculation system of the seventy-third exemplary embodiment,
in the case in which it is assumed that two auxiliary lines crossing the guiding reference points or the vicinities thereof are formed along an edge of an image passing the guiding reference points or the vicinities thereof, the line-of-sight guiding direction calculating device calculates center directions of obtuse angles among angles formed by the imaginary auxiliary lines as the line-of-sight guiding directions.

With such a constitution, in the case in which it is assumed that two auxiliary lines crossing the guiding reference points or the vicinities thereof are formed along an edge of an image passing the guiding reference points or the vicinities thereof, center directions of obtuse angles among angles formed by the imaginary auxiliary lines are calculated as the line-of-sight guiding directions by the line-of-sight guiding direction calculating device.

Consequently, since directions from the inside of an image object toward apexes of a projected part can be calculated as line-of-sight guiding directions, there is an advantage that it can be calculated more appropriately in which direction an image tends to guide a line-of-sight.

Here, assuming that imaginary auxiliary lines crossing guiding reference points or vicinities thereof are formed along an edge of an image, the line-of-sight guiding direction calculating device calculates line-of-sight guiding directions. From a viewpoint of obtaining an appropriate eye flow, it is preferable to calculate line-of-sight guiding directions assuming that imaginary auxiliary lines crossing guiding reference points are formed along an edge of an image. However, in the case in which it is difficult to form imaginary auxiliary lines crossing guiding reference points in terms of calculation or in the case in which an eye flow is obtained at low accuracy from a viewpoint of reduction in an amount of calculation or the like, line-of-sight guiding directions may be calculated assuming that imaginary auxiliary lines crossing vicinities of guiding reference points are formed along an edge of an image in a range in which an inappropriate eye flow is not obtained.

[Seventy-fifth Exemplary Embodiment] A line-of-sight guiding degree calculation system of a seventy-fifth exemplary embodiment is characterized in that, in the line-of-sight guiding degree calculation system of the seventy-third or the seventy-fourth exemplary embodiment,
the line-of-sight guiding degree calculating device calculates distances from a center of gravity of an image object, a contour of which is formed including an edge of an image passing the guiding reference points or the vicinities thereof, to the guiding reference points as the line-of-sight guiding intensities.

With such a constitution, distances from a center of gravity of an image object, a contour of which is formed including an edge of an image passing guiding reference points or vicinities thereof, to the guiding reference points are calculated as line-of-sight guiding intensities by the line-of-sight guiding degree calculating device.

As a sharpness degree of a projected part of an image object is larger, a line-of-sight tends to be guided more to the projected part. In addition, distances from a center of gravity of the image object to guiding reference points increase as the sharpness degree is larger. Therefore, since line-of-sight guiding intensities corresponding to magnitudes of the sharpness degree of the projected part of the image object can be calculated, there is an advantage that it can be calculated more appropriately in which direction an image guides a line-of-sight.

Here, the image object refers to an area having a contour in an image. This area may be a closed area or an open area. The same holds true for line-of-sight guiding degree calculation systems of seventy-sixth and seventy-seventh exemplary embodiments to be described below.

[Seventy-sixth Exemplary Embodiment] A line-of-sight guiding degree calculation system of a seventy-sixth exemplary embodiment is characterized in that, in the line-of-sight guiding degree calculation system of any one of the seventy-third to the seventy-fifth exemplary embodiments,
in the case in which it is assumed that two auxiliary lines crossing the guiding reference points or the vicinities thereof are formed along an edge of an image passing the guiding reference points or the vicinities thereof, the line-of-sight guiding intensity calculating device calculates distances from points where bisectors of acute angles among angles formed by the imaginary auxiliary lines cross a contour line of an image object, a contour of which is formed including the edge, to the guiding reference points as the line-of-sight guiding intensities.

With such a constitution, in the case in which it is assumed that two auxiliary lines crossing guiding reference points or vicinities thereof are formed along an edge of an image passing the guiding reference points or the vicinities thereof, distances from points where bisectors of acute angles among angles formed by the imaginary auxiliary lines cross a contour line of an image object, a contour of which is formed including the edge, to the guiding reference points are calculated as line-of-sight guiding intensities by the line-of-sight guiding intensity calculating device.

As a sharpness degree of a projected part of an image object is larger, a line-of-sight tends to be guided more to the projected part. In addition, distances from points where bisectors of acute angles among angles formed by imaginary auxiliary lines cross a contour line of an image object to guiding reference points increase as the sharpness degree is larger. Therefore, since a line-of-sight guiding intensities corresponding to magnitudes of the sharpness degree of the projected part of the image object can be calculated, there is an advantage that it can be calculated more appropriately in which direction an image tends to guide a line-of-sight.

Here, assuming that imaginary auxiliary lines crossing guiding reference points or vicinities thereof are formed along an edge of an image, the line-of-sight guiding intensity calculating device calculates line-of-sight guiding intensities. From a viewpoint of obtaining an appropriate eye flow, it is preferable to calculate a line-of-sight guiding intensities assuming that imaginary auxiliary lines crossing guiding reference points are formed along an edge of an image. However, in the case in which it is difficult to form imaginary auxiliary lines crossing guiding reference points in terms of calculation or in the case in which an eye flow is obtained at low accuracy from a viewpoint of reduction in an amount of calculation or the like, line-of-sight guiding intensities may be calculated assuming that imaginary auxiliary lines crossing vicinities of guiding reference points are formed along an edge of an image in a range in which an inappropriate eye flow is not obtained. The same holds true for a line-of-sight guiding degree calculation system of a seventy-seventh exemplary embodiment to be described below.

[Seventy-seventh Exemplary Embodiment] A line-of-sight guiding degree calculation system of a seventy-seventh exemplary embodiment is characterized in that, in the line-of-sight guiding degree calculation system of any one of the seventy-third to seventy-sixth exemplary embodiments,
in the case in which it is assumed that two auxiliary lines crossing the guiding reference points or the vicinities thereof are formed along an edge of an image passing the guiding reference points or the vicinities thereof, the line-of-sight guiding intensity calculating device calculates angles formed by the imaginary auxiliary lines as the line-of-sight guiding intensities.

With such a constitution, in the case in which it is assumed that two auxiliary lines crossing guiding reference points or vicinities thereof are formed along an edge of an image passing the guiding reference points or the vicinities thereof, angles formed by the imaginary auxiliary lines are calculated as a line-of-sight guiding intensities by the line-of-sight guiding intensity calculating device.

As a sharpness degree of a projected part of an image object is larger, a line-of-sight tends to be guided more to the projected part. In addition, the angles formed by the imaginary auxiliary lines are smaller as the sharpness degree is larger. Therefore, since line-of-sight guiding intensities corresponding to magnitudes of the sharpness degree of the projected part of the image object can be calculated, there is an advantage that it can be calculated more appropriately in which direction an image tends to guide a line-of-sight.

[Seventy-eighth Exemplary Embodiment] On the other hand, in order to attain the object, a line-of-sight guiding degree calculation program of a seventy-eighth exemplary embodiment is a program to calculate a degree, at which an image guides a line-of-sight, on the basis of image data, characterized by including:
a program for causing a computer to execute processing including: approximating a bent part included in the image to a projected part on the basis of the image data; detecting guiding reference points to be references for guiding a line-of-sight out of the projected part approximated in the projected part approximating; and calculating line-of-sight guiding degrees indicating degrees, at which a line-of-sight is guided, with respect to the guiding reference points detected in the guiding reference point detecting.

With such a constitution, when the program is read by the computer, and the computer executes the processing in accordance with the read program, an action and an advantage equivalent to those in the line-of-sight guiding degree calculation system of the sixty-seventh exemplary embodiment are obtained.

[Seventy-ninth Exemplary Embodiment] On the other hand, in order to attain the object, a line-of-sight guiding degree calculation method of a seventy-ninth exemplary embodiment is a method of calculating a degree, at which an image guides a line-of-sight, on the basis of image data, characterized by including:
approximating a bent part included in the image to a projected part on the basis of the image data; detecting guiding reference points to be references to guide a line-of-sight out of the projected part approximated in the projected part approximating; and calculating line-of-sight guiding degrees indicating degrees, at which a line-of-sight is guided, with respect to the guiding reference points detected in the guiding reference point detecting.

Consequently, an advantage equivalent to that in the line-of-sight guiding degree calculation system of the sixty-seventh exemplary embodiment is obtained.

### BRIEF DESCRIPTION OF THE DRAWINGS

FIG. 1 is a schematic block diagram showing a structure of a layout apparatus 100;

FIG. 2 is a flowchart showing line-of-sight guiding degree calculation processing;

FIG. 3 is a schematic diagram showing a vector image including an image object 10;

FIG. 4 is a schematic diagram showing a data structure of vector image data;

FIG. 5 is a schematic diagram in which a vector image is arranged on a two-dimensional coordinate space;

FIG. 6 is a flowchart showing polygon approximation processing;

FIG. 7 is a schematic diagram showing an image object 10 having a curved line part;

FIG. 8 is a schematic diagram showing a case in which the image object 10 is approximated to a triangle;

FIG. 9 is a schematic diagram showing a case in which the image object 10 is approximated to a square;

FIG. 10 is a schematic diagram showing a case in which the image object 10 is approximated to a pentagon;

FIG. 11 is a schematic diagram showing a case in which an octagonal image object 10 is approximated to a square;

FIG. 12 is a schematic diagram showing a case in which the octagonal image object 10 is approximated to a pentagon;

FIG. 13 is a schematic diagram showing an example of calculation for calculating guiding reference points;

FIG. 14 is a schematic diagram showing line-of-sight guiding directions at guiding reference points;

FIG. 15 is a schematic vector synthetic diagram for obtaining a line-of-sight guiding direction a;

FIG. 16 is a schematic vector synthetic diagram for obtaining a line-of-sight guiding direction b;

FIG. 17 is a schematic vector synthetic diagram for obtaining a line-of-sight guiding direction c;

FIG. 18 is a schematic diagram showing center-of-gravity distances from guiding reference points;

FIG. 19 is table showing line-of-sight guiding directions and line-of-sight guiding intensities at respective guiding reference points;

FIG. 20 is a schematic diagram showing a case in which a magazine page is laid out using a layout template;

FIG. 21 is a schematic diagram showing a case in which line-of-sight guiding information 14 is displayed;

FIG. 22 is a schematic diagram showing a case in which image objects 12a to 12d are arranged referring to the line-of-sight guiding information 14;

FIG. 23 is a schematic diagram showing inside distances from guiding reference points;

FIG. 24 is a table showing an example of calculation for calculating coordinates of points where imaginary auxiliary lines cross opposed sides;

FIG. 25 is a table showing an example of calculation for calculating inside distances;

FIG. 26 is a table showing line-of-sight guiding directions and line-of-sight guiding intensities at respective guiding reference points;

FIG. 27 is a flowchart showing line-of-sight guiding degree calculation processing in a third embodiment;

FIG. 28 is a schematic diagram showing an image object 10 including a curved line part after edge extraction;

FIG. 29 is a schematic diagram showing a structure of vector image data of the image object 10 having the curved line part;

FIG. 30A is a schematic diagram showing the image object 10 having the curved line part;

FIG. 30B is a schematic diagram in which a part of (2) in FIG. 30A is subjected to polygon approximation; and

FIG. 31 is a conceptual schematic diagram showing an example of a computer readable recording medium in which a control program is recorded.

### DETAILED DESCRIPTION OF PREFERRED EMBODIMENTS

### First Exemplary Embodiment

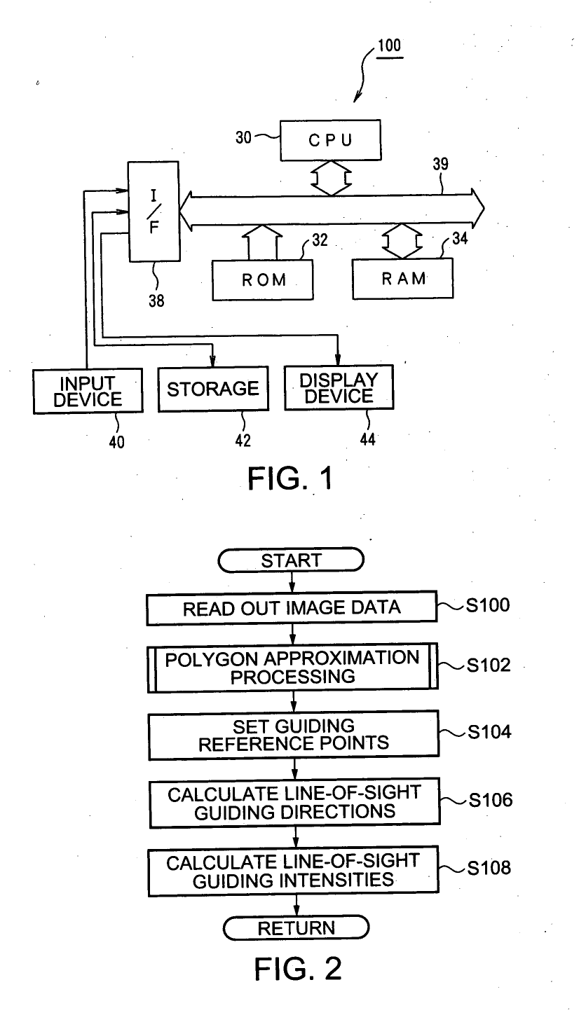

A first exemplary embodiment of the invention will be hereinafter explained with reference to the drawings. FIGS. 1 to 22 are diagrams showing a first exemplary embodiment of a line-of-sight guiding degree calculation system and a line-of-sight guiding degree calculation program as well as a line-of-sight guiding degree calculation method in accordance with the exemplary embodiments.

In this exemplary embodiment, the line-of-sight guiding degree calculation system and the line-of-sight guiding degree calculation program as well as the line-of-sight guiding degree calculation method in accordance with the embodiments are applied to a case in which directions in which an image object guides a line-of-sight and intensities at which the image object guides the line-of-sight are calculated.

First, a structure of a layout apparatus 100, to which the invention is applied, will be explained with reference to FIG. 1.

FIG. 1 is a schematic block diagram showing the structure of the layout apparatus 100.

As shown in FIG. 1, the layout apparatus 100 includes a CPU 30 that controls arithmetic operations and the entire system on the basis of a control program, a ROM 32 that stores the control program and the like of the CPU 30 in a predetermined area, a RAM 34 to store data read out from the ROM 32 or the like and arithmetic operation results necessary in arithmetic operation processes of the CPU 30, and an I/F 38 that interfaces input/output of data to external apparatuses. These devices are connected to one another and so as to be capable of exchanging data via a bus 39 serving as a data line for transferring data.

An input device 40 including a keyboard, a mouse, or the like which is capable of inputting data as a human interface, a storage 42 that stores data, tables, and the like as files, and a display device 44 that displays a screen on the basis of an image signal are connected to the I/F 38 as external devices.

The CPU 30 includes a microprocessing unit (MPU) or the like, starts a predetermined program stored in a predetermined area of the ROM 32, and executes line-of-sight guiding degree calculation processing shown in a flowchart of FIG. 2 in accordance with the program.

FIG. 2 is a flowchart showing line-of-sight guiding degree calculation processing.

The line-of-sight guiding degree calculation processing is processing to calculate directions in which an image object guides a line-of-sight and intensities at which the image object guides the line-of-sight. When the line-of-sight guiding degree calculation processing is executed in the CPU 30, as shown in FIG. 2, first, the CPU 30 shifts to step S100.

In step S100, the CPU 30 reads out image data from the storage 42 and shifts to step S102. In step S102, the CPU 30 approximates an image object having a curved line part to a polygon on the basis of the read-out image data and shifts to step S104. In step S104, the CPU 30 sets guiding reference points to be references for guiding a line-of-sight to the image object approximated to the polygon and shifts to step S106.

In step S106, the CPU 30 calculates line-of-sight guiding directions, in which the line-of-sight is guided, with respect to the set guiding reference points and shifts to step S108. In step S108, the CPU 30 calculates line-of-sight guiding intensities indicating intensities at which the line-of-sight is guided with respect to the set guiding reference points, ends the series of processing, and returns the processing to the original processing.

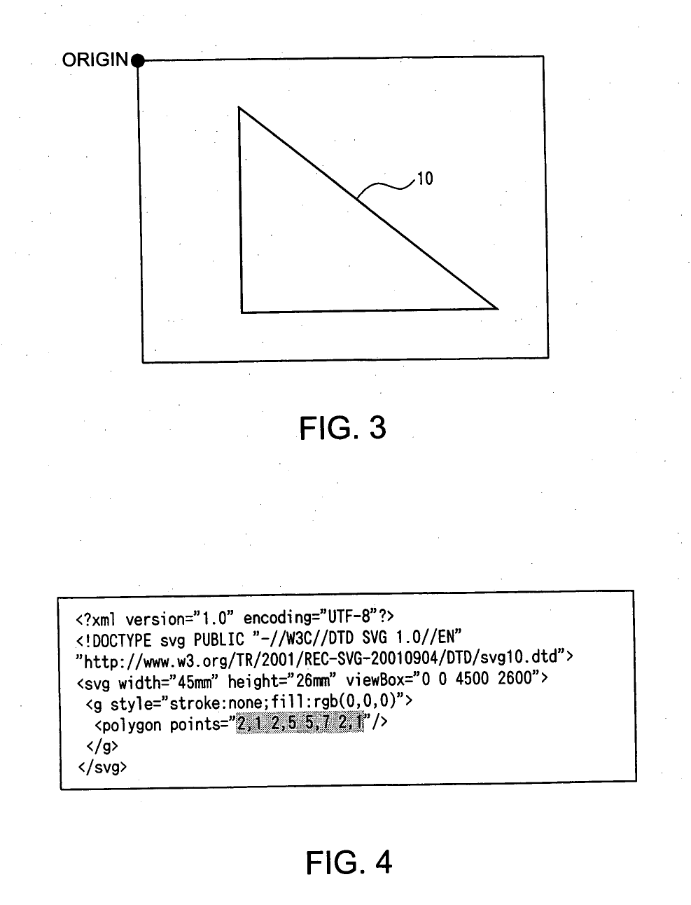

Next, image data input processing in step S100 will be explained in detail with reference to FIGS. 3 to 5.

FIG. 3 is a schematic diagram showing a vector image including an image object 10.

In step S100, as shown in FIG. 3, the CPU 30 reads out image data of the vector image including the image object 10 from the storage 42. In an example of FIG. 3, the image object 10 is formed in a right-angled triangle.

FIG. 4 is a schematic diagram showing data structure of vector image data.

As shown in FIG. 4, the vector image data has a data structure, in which a shape and a size of the image object 10 are represented by numerical values, and can be constituted by a representative data format such as SVG. In an example of FIG. 4, coordinates of respective apexes of the image object 10 are designated in a tag indicting that a polygon is drawn (<polygon points>). This indicates that the image object 10 is formed by drawing straight lines between designated coordinates adjacent to each other.

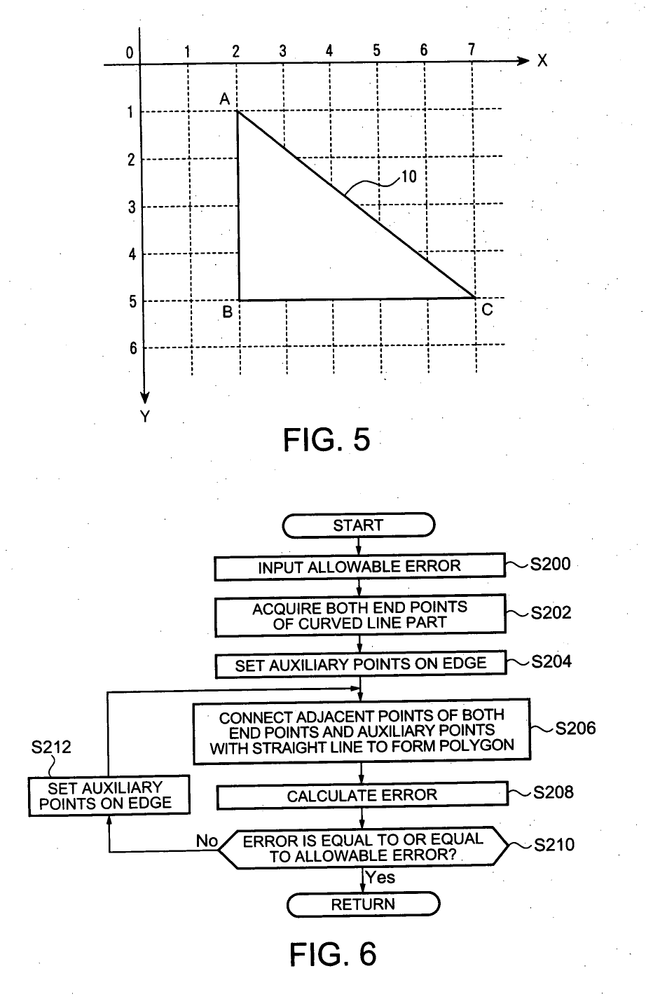

FIG. 5 is a schematic diagram in which a vector image is arranged on a two-dimensional coordinate space.

As shown in FIG. 5, the vector image can be arranged on the two-dimensional coordinate space. In an example of FIG. 5, the vector image is arranged on the two-dimensional coordinate space with an upper left of the vector image as an origin.

Next, polygon approximation processing in step S102 will be explained in detail with reference to FIGS. 6 to 12.

FIG. 6 is a flowchart showing the polygon approximation processing.

The polygon approximation processing is processing to approximate the image object 10 having a curved line part to a polygon. When the polygon approximation processing is executed in step S102, as shown in FIG. 6, first, the CPU 30 shifts to step S200.

In step S200, the CPU 30 inputs an allowable distance from the input device 40 and shifts to step S202. In step S202, the CPU 30 acquires both end points of the curved line part of the image object 10 on the basis of the read-out vector image data and shifts to step S204.

In step S204, the CPU 30 sets auxiliary points on an edge of the curved line part and in positions where distances from a straight line connecting both the end points of the curved line part to the edge are maximized and shifts to step S206. In step S206, the CPU 30 connects points adjacent to each other on the edge among both the end points of the curved line part and the respective auxiliary points set so far with straight lines to form a polygon and shifts to step S208.

In step S208, the CPU 30 calculates a distance between the image object 10 and the polygon formed in step S206. For example, the CPU 30 calculates distances from the straight lines connecting points adjacent to each other on the edge among both the end points of the curved line part and the auxiliary points to the auxiliary points set in positions where distances to the edge are maximized.

In step S210, the CPU 30 judges whether the distances calculated in step S208 are equal to or less than the inputted allowable distance. When it is judged that the calculated distances are equal to or less than the allowable distance (Yes), the CPU 30 ends the series of processing and returns the processing to the original processing.

On the other hand, when it is judged in step S210 that the distances calculated in step S208 are larger than the allowable distance (No), the CPU 30 shifts to step S212, sets auxiliary points on the edge of the curved line part and in positions where distances from straight lines connecting points adjacent to each other on the edge among both the end points of the curved line part and the respective auxiliary points set so far to the edge are maximized, and shifts to step S206.

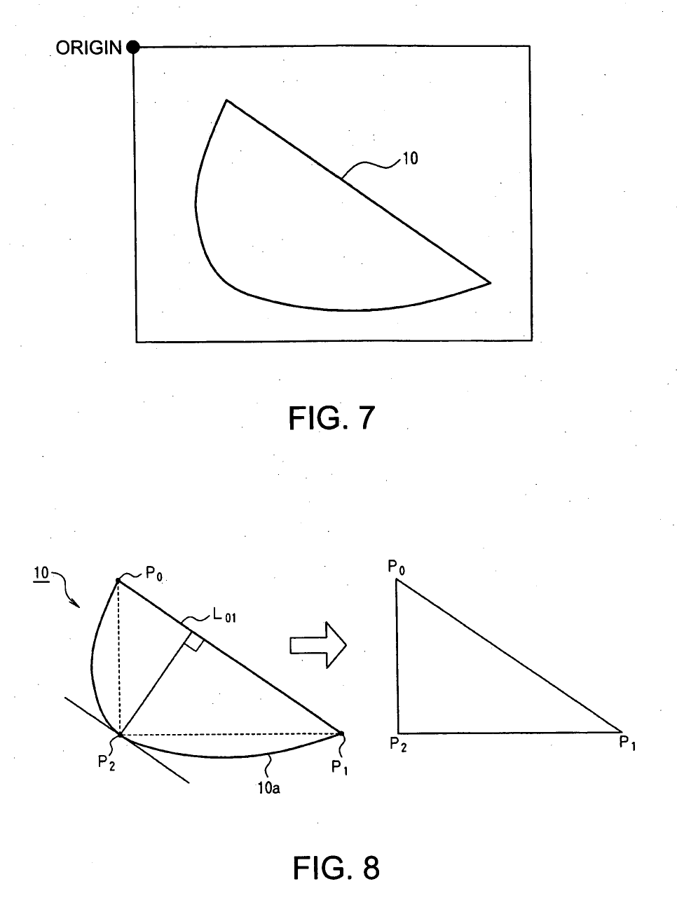

FIG. 7 is a schematic diagram showing an image object 10 having a curved line part.

As shown in FIG. 7, in the case in which the image object 10 having the curved line part is included in a vector image, guiding reference points cannot be set easily. Therefore, it is necessary to approximate such an image object 10 to a polygon.

FIG. 8 is a schematic diagram showing a case in which the image object 10 is approximated to a triangle.

In the case in which the image object 10 in FIG. 7 is approximated to a triangle, as shown in FIG. 8, first, both end points P0 and P1 of a curved line part are acquired on the basis of vector image data. Subsequently, an auxiliary point P2 is set in a position where a distance from a straight line L01 connecting both the end points P0 and P1 to an edge 10a is maximized. Then, points adjacent to each other on the edge 10a among both the end points P0 and P1 and the auxiliary point P2 are connected by straight lines to form a triangle. Here, if the distance is equal to or less than the allowable distance, the polygon approximation processing ends, and the image object 10 in FIG. 7 is approximated to the triangle formed by both the end points P0 and P1 and the auxiliary point P2.

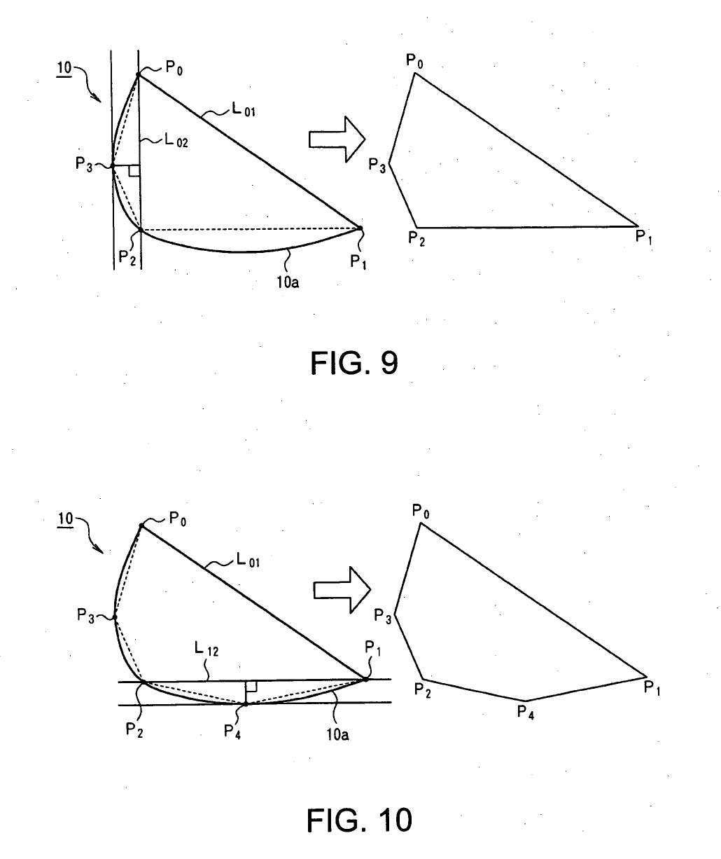

FIG. 9 is a schematic diagram showing a case in which the image object 10 is approximated to a square.

If the distance is larger than the allowable distance in the case of FIG. 8, as shown in FIG. 9, an auxiliary point P3 is further set in a position where a distance from a straight line L02 connecting the end point P0 and the auxiliary point P2 to the edge 10a, is maximized. Here, although the auxiliary point P3 is set as a most distant point, more specifically, a position where a distance from the straight lines L01 and L02 formed so far to the edge 10a is maximized is set as a most distant point, and as a result, the auxiliary point P3 corresponds to this position. The same holds true for FIGS. 10 to 12 to be described below. Then, points adjacent to each other on the edge 10a among both the end points P0 and P1 and the auxiliary points P2 and P3 are connected by straight lines to form a square. Here, if the distance is equal to or less than the allowable distance, the polygon approximation processing ends, and the image object 10 in FIG. 7 is approximated to the square formed by both the end points P0 and P1 and the auxiliary points P2 and P3.

FIG. 10 is a schematic diagram showing a case in which the image object 10 is approximated to a pentagon.

If the distance is larger than the allowable distance in the case of FIG. 9, as shown in FIG. 10, an auxiliary point P4 is further set in a position where a distance from a straight line L12 connecting the end point P1 and the auxiliary point P2 to the edge 10a is maximized. Here, points adjacent to each other on the edge 10a among both the end points P0 and P1 and the auxiliary points P2 to P4 are connected by straight lines to form a pentagon. Here, if the distance is equal to or less than the allowable distance, the polygon approximation processing ends, and the image object 10 in FIG. 7 is approximated to a pentagon formed by both the end points P0 and P1 and the auxiliary points P2 to P4.

In addition, in the case in which the image object 10 is constituted by a polygon, it is also possible to approximate the polygon to a polygon with a reduced number of angles.

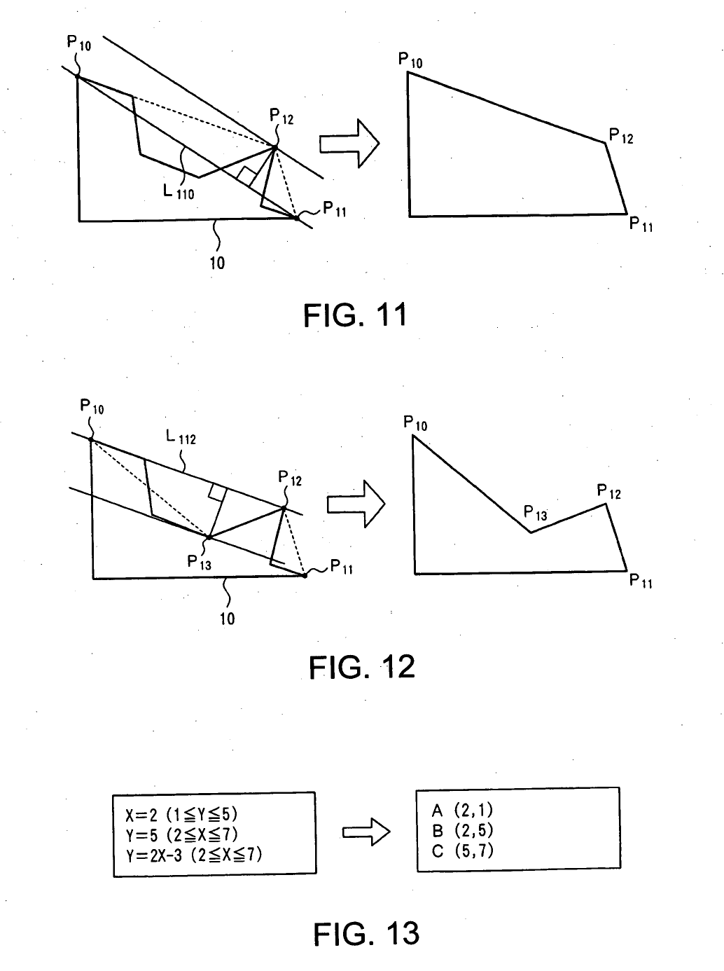

FIG. 11 is a schematic diagram showing a case in which an octagonal image object 10 formed in a shape like the ria coast is approximated to a square.

In the case in which the octagonal image object 10 is approximated to a square, as shown in FIG. 11, first, any one of apexes of the image object 10 is set as a reference point P10, and another apex at which a distance from the reference point P10 is maximized is set as a reference point P11. Subsequently, an apex where a distance from a straight line L110 connecting the reference points P10 and P11 is maximized among the other apexes between the reference points P10 and P11 is set as a reference point P12. Then, the reference points P10 and P12 are connected by a straight line and the reference points P12 and P11 are connected by a straight line to form a square. Here, if an error is equal to or less than an allowable error, the polygon approximation processing ends, and the octagonal image object 10 is approximated to the square that is formed including the reference points P10 to P12.

Note that, as a method of selecting two points in the case in which a complex boundary is simplified, it is not always necessary to select a point where a distance from one selected point is the largest. It is possible to select two points at both ends of a part, which is desired to be simplified, at will. In addition, concerning the reference points P10 and P11, judgment on whether the image object 10 is approximated to a polygon with a reduced number of angles depends upon, for example, judgment that a space between the reference points P10 and P11 is complicated according to some index. This judgment may be performed manually or may be performed automatically.

FIG. 12 is a schematic diagram showing a case in which the octagonal image object 10 is approximated to a pentagon.

If the distance is larger than the allowable distance in the case of FIG. 11, as shown in FIG. 12, an apex at which a distance from a straight line L112 connecting the reference points P10 and P12 is maximized among the other apexes between the reference points P10 and P12 is further set as a reference point P13. Then, the reference points P10 and P13 are connected by a straight line, the reference points P13 and P12 are connected by a straight line, and the reference points P12 and P11 are connected by a straight line to form a pentagon. Here, if the distance is equal to or less than the allowable distance, the polygon approximation processing ends, and the octagonal image object 10 is approximated to the pentagon that is formed including the reference points P10 to P13.

Next, guiding reference point setting processing in step S104 will be explained in detail with reference to FIG. 13.

In step S104, respective apexes of the image object 10 approximated to the polygon are set as guiding reference points. To simplify explanation, the image object 10 (right-angled triangle) in FIG. 4 will be explained as an example. As shown in FIG. 4, in the case in which coordinates of respective apexes A to C of the image object 10 are included in vector image data, it is possible to set guiding reference points by acquiring the coordinates of the respective apexes A to C from the vector image data.

Note that, in the case in which the coordinates of the respective apexes A to C are not included in vector image data, the coordinates can be calculated by solving an equation for contour line of the image object 10.

FIG. 13 is a schematic diagram showing an example of calculation for calculating guiding reference points.

In the example of FIG. 13, an equation for a straight line connecting apexes A and B (hereinafter referred to as straight line AB) of a contour line of the image object 10 is represented as X=2(1≦Y≦5), an equation for a straight line connecting apexes B and C (hereinafter referred to as straight line BC) of the contour line of the image object 10 is represented as Y=5(2≦X≦7), and an equation for a straight line connecting apexes C and A (hereinafter referred to as straight line CA) of the contour line of the image object 10 is represented as Y=2X−3(2≦X≦7). Thus, coordinates of the respective apexes A to C can be calculated by solving the equations for the straight lines. As a result, the coordinates of the respective apexes A to C can be calculated as A(2, 1), B(2, 5), and C(5, 7).

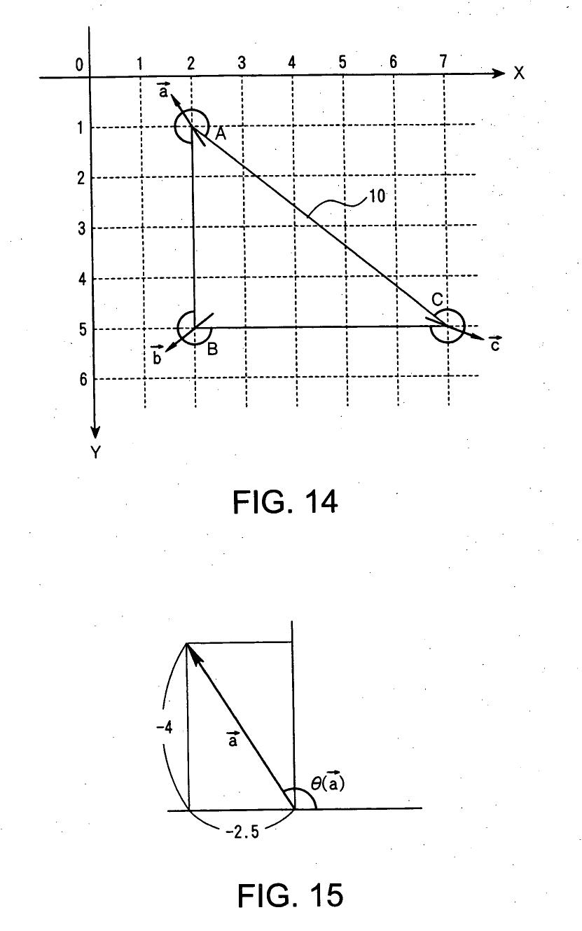

Next, line-of-sight guiding direction calculation processing in step S106 will be explained in detail with reference to FIGS. 14 to 17.

In step S106, two auxiliary lines crossing guiding reference points are formed imaginarily along the contour of the image object 10 for the respective guiding reference points, and a direction in which a bisector of an obtuse angle, among angles formed by the imaginary auxiliary lines, extends outward from the guiding reference points is calculated as a line-of-sight guiding direction.

FIG. 14 is a schematic diagram showing line-of-sight guiding directions at guiding reference points.

As shown in FIG. 14, when it is assumed that line-of-sight guiding directions at guiding reference points A to C are a to c, respectively, imaginary auxiliary lines at the guiding reference point A are a straight line AB and a straight line Ca, imaginary auxiliary lines at the guiding reference point B are the straight line AB and a straight line BC, imaginary auxiliary lines at the guiding reference point C are the straight line CA and the straight line BC, the ling-of-sight guiding directions a to c can be calculated as (−2.5, −4), (−2.5, 2), and (5, 2) according to expressions (1) to (3) below.
[Numeral 1]

$$\vec{a} = \frac{\vec{BA} + \vec{CA}}{2} = \frac{( 0 , - 4 ) + ( - 5 , - 4 )}{2} = \frac{( - 5 , - 8 )}{2} = ( - 2.5 , - 4 ) \qquad ( 1 )$$

[Numeral 2]

$$\vec{b} = \frac{\vec{AB} + \vec{CB}}{2} = \frac{( 0 , 4 ) + ( - 5 , 0 )}{2} = \frac{( - 5 , 4 )}{2} = ( - 2.5 , 2 ) \qquad ( 2 )$$

[Numeral 3]

$$\vec{c} = \frac{\vec{AC} + \vec{BC}}{2} = \frac{( 5 , 4 ) + ( 5 , 0 )}{2} = \frac{( 10 , 4 )}{2} = ( 5 , 2 ) \qquad ( 3 )$$

Moreover, when the line-of-sight guiding directions a to c are normalized to vectors of a size “1”, respectively, the line-of-sight guiding directions a to c can be calculated as (−0.53, −0.85), (−0.78, 0.62), and (0.93, 0.37) according to expressions (4) to (6) below.
[Numeral 4]

$$\frac{\vec{a}}{\vert \vec{a} \vert} = ( \frac{- 2.5}{\sqrt{22.25}} , \frac{- 4}{\sqrt{22.25}} ) \approx ( - 0.53 , - 0.85 ) \qquad ( 4 )$$

[Numeral 5]

$$\frac{\vec{b}}{\vert \vec{b} \vert} = ( \frac{- 2.5}{\sqrt{10.25}} , \frac{2}{\sqrt{10.25}} ) \approx ( - 0.78 , 0.62 ) \qquad ( 5 )$$

[Numeral 6]

$$\frac{\vec{c}}{\vert \vec{c} \vert} = ( \frac{5}{\sqrt{29}} , \frac{2}{\sqrt{29}} ) \approx ( 0.93 , - 0.37 ) \qquad ( 6 )$$

FIG. 15 is a schematic vector synthetic diagram to obtain the line-of-sight guiding direction a.

In addition, when an angle of a line-of-sight guiding direction with a direction of three o'clock as 0°, as shown in FIG. 15, the angle can be calculated as “122°” for the line-of-sight guiding direction a according to expression (7) below.
[Numeral 7]

$$Direction of \vec{a} ( radian ) = \frac{π}{2} + arctan ( \frac{- 2.5}{- 4} ) \approx 2.13 \\ Direction of \vec{a} ( degree ) = 122 \qquad ( 7 )$$

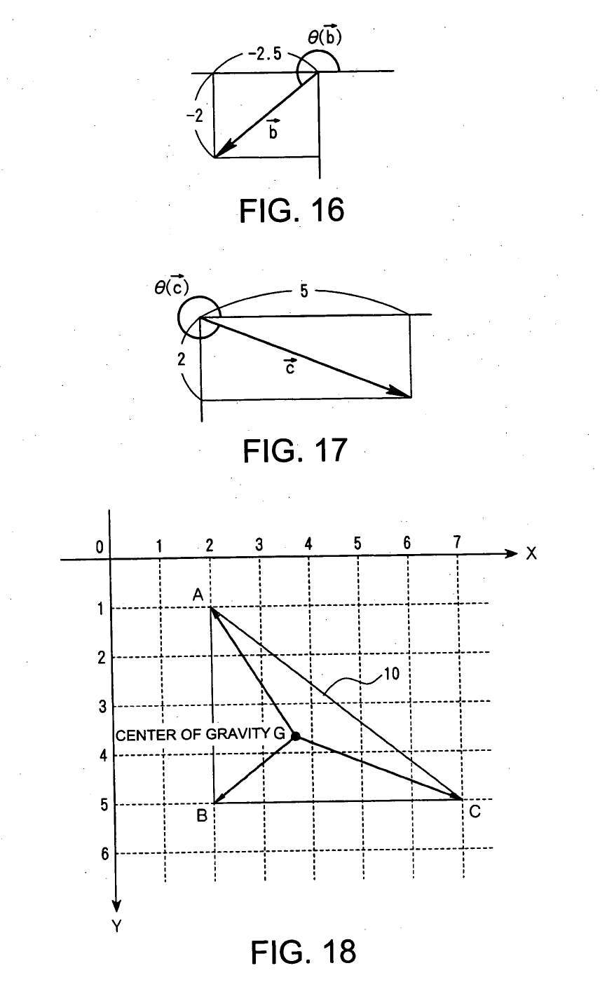

FIG. 16 is a schematic vector synthetic diagram to obtain the line-of-sight guiding direction b.

Similarly, as shown in FIG. 16, the angle can be calculated as “219°” for the line-of-sight guiding direction b according to expression (8) below.
[Numeral 8]

$$Direction of \vec{b} ( radian ) = π + arctan ( \frac{- 2}{- 2.5} ) \approx 3.82 \\ Direction of \vec{b} ( degree ) = 219 \qquad ( 8 )$$

FIG. 17 is a schematic vector synthetic diagram to obtain the line-of-sight guiding direction c.

Similarly, as shown in FIG. 17, the angle can be calculated as “338°” for the line-of-sight guiding direction c according to expression (9) below.
[Numeral 9]

$$Direction of \vec{c} ( radian ) = \frac{3}{2} π + arctan ( \frac{5}{2} ) \approx 5.90 \\ Direction of \vec{c} ( degree ) = 338 \qquad ( 9 )$$

Next, line-of-sight guiding intensity calculation processing in step S108 will be explained in detail with reference to FIG. 18.

In step S108, for each guiding reference point, a distance from a center of gravity G of the image object 10 to the guiding reference point is calculated as a line-of-sight guiding intensity.

FIG. 18 is a schematic diagram showing center-of-gravity distances from guiding reference points.

As shown in FIG. 18, coordinates of the center of gravity G of the image object 10 can be calculated as (3.67, 3.67) according to expression (10) below.
[Numeral 10]

$$\vec{OG} = \frac{\vec{OA} + \vec{OB} + \vec{OC}}{3} \\ = ( \frac{11}{3} , \frac{11}{3} ) \\ \approx ( 3.67 , 3.67 ) \qquad ( 10 )$$

Therefore, center-of-gravity distances from the respective guiding reference points A to C can be calculated as “3.14”, “2.13”, and “3.59” according to expressions (11) to (13) below.
[Numeral 11]

$$\vert \vec{GA} \vert = \vert \vec{OA} - \vec{OG} \vert \\ = \sqrt{{( 2 - \frac{11}{3} )}^{2} - {( 1 - \frac{11}{3} )}^{2}} \\ \approx 3.14 \qquad ( 11 )$$

[Numeral 12]

$$\vert \vec{GB} \vert = \vert \vec{OB} - \vec{OG} \vert \\ = \sqrt{{( 2 - \frac{11}{3} )}^{2} - {( 5 - \frac{11}{3} )}^{2}} \\ \approx 2.13 . \qquad ( 12 )$$

[Numeral 13]

$$\vert \vec{GC} \vert = \vert \vec{OC} - \vec{OG} \vert \\ = \sqrt{{( 7 - \frac{11}{3} )}^{2} - {( 5 - \frac{11}{3} )}^{2}} \\ \approx 3.59 . \qquad ( 13 )$$

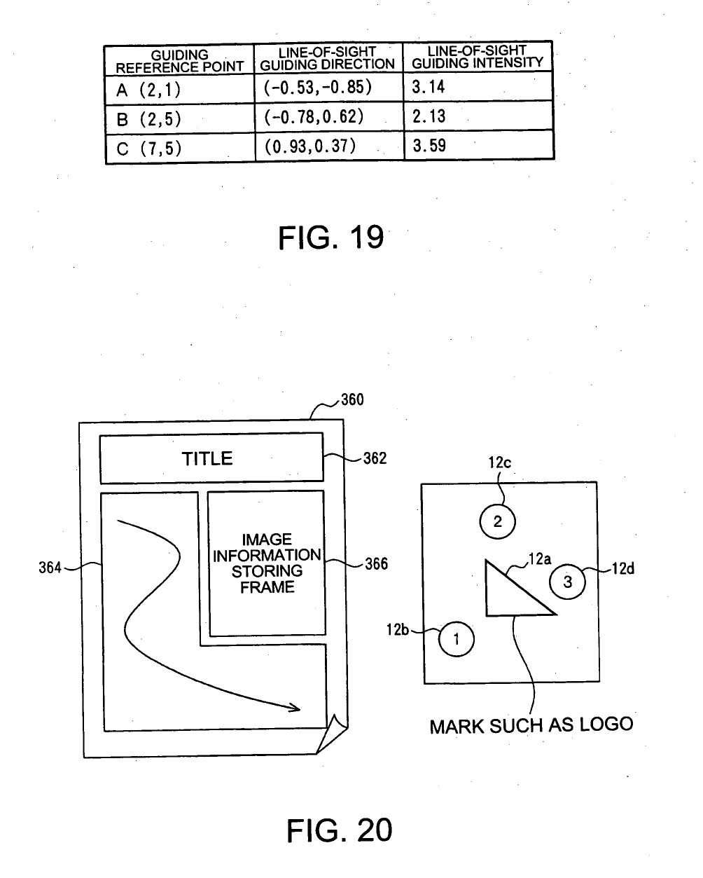

FIG. 19 is a table showing line-of-sight guiding directions and line-of-sight guiding intensities of respective guiding reference points.

From the above, a line-of-sight guiding direction and a line-of-sight guiding intensity at the guiding reference point A can be calculated as (−0.53, −0.85) and “3.14” as shown in FIG. 19. This indicates that a line-of-sight is guided in a direction of (−0.53, −0.85) with the apex A of the image object 10 as a reference at a magnitude of “3.14”.

A line-of-sight guiding direction and a line-of-sight guiding intensity at the guiding reference point B can be calculated as (−0.78, 0.62) and “2.13”. This indicates that a line-of-sight is guided in a direction of (−0.78, 0.62) with the apex B of the image object 10 as a reference at a magnitude of “2.13”.

A line-of-sight guiding direction and a line-of-sight guiding intensity at the guiding reference point C can be calculated as (0.93, 0.37) and “3.59”. This indicates that a line-of-sight is guided in a direction of (0.93, 0.37) with the apex C of the image object 10 as a reference at a magnitude of “3.59”.

Next, operations of this exemplary embodiment will be explained.

In the layout apparatus 100, vector image data is read out through step S100. At this point, in the case in which the image object 10 having a curved line part is included in a vector image, the image object 10 is approximated to a polygon on the basis of the read-out vector image data through steps S102 and S104, and respective apexes of the approximated image object 10 are set as guiding reference points.

Then, through step S106, for each of the guiding reference points, two auxiliary lines crossing guiding reference points are formed imaginarily along the contour of the image object 10, and a direction in which a bisector of an obtuse angle among angles formed by the imaginary auxiliary lines extends outward from the guiding reference point is calculated as a line-of-sight guiding direction. In addition, through step S108, for each of the guiding reference points, a center-of-gravity distance is calculated as a line-of-sight guiding intensity.

When line-of-sight guiding directions and line-of-sight guiding intensities are calculated for the image object 10 in this way, it can be grasped quantitatively in which direction the image object 10 tends to guide a line-of-sight on the basis of the line-of-sight guiding directions and the line-of-sight guiding intensities.

The line-of-sight guiding directions and the line-of-sight guiding intensities can be applied to layout.

FIG. 20 is a schematic diagram showing a case in which a magazine page is designed using a layout template.

As shown in FIG. 20, in the case in which a magazine page is laid out using a layout template in which a title information storing frame 362 to store title information, a character information storing frame 364 to store character information, and an image information storing frame 366 to store image information are arranged in a layout area 360, it is considered to store title information of an article in the title information storing frame 362, store character information of the article in the character information storing frame 364, and store image objects 12a to 12d shown in the right side of the figure in the image information storing frame 366. The image object 12a is, for example, a mark such as a logo. In addition, the image objects 12b to 12d are, for example, appeal points such as business areas, and numbers in the object indicate priorities for appeal.

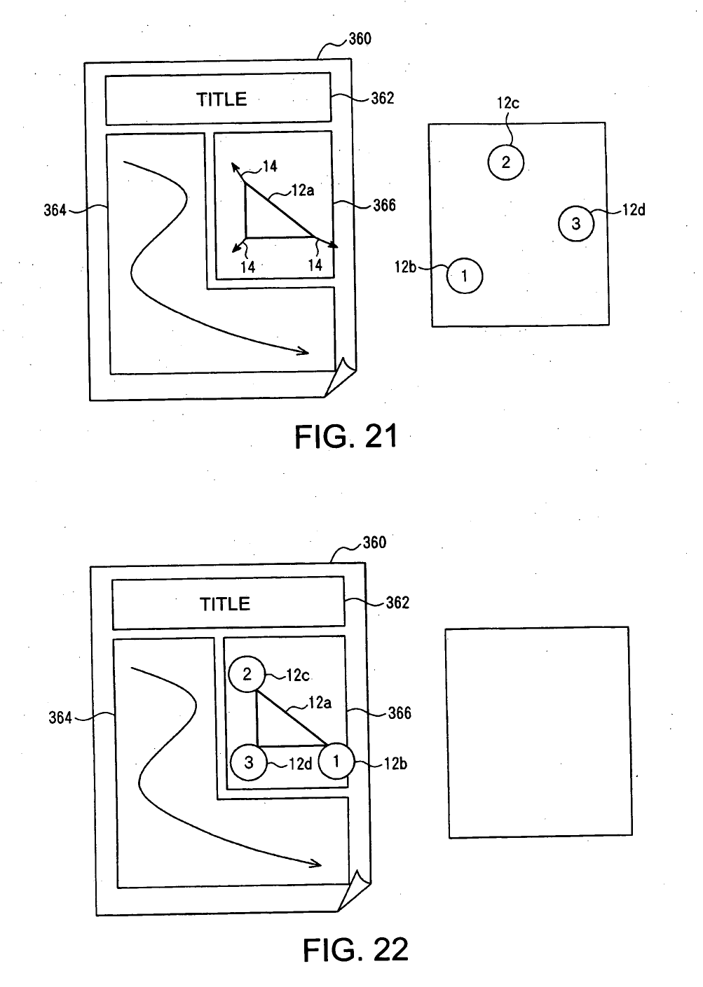

FIG. 21 is a schematic diagram showing a case in which a line-of-sight guiding information 14.

An editor often wonders how the image objects 12b to 12d should be arranged with respect to the image object 12a. Thus, as shown in FIG. 21, the line-of-sight guiding information 14 is displayed in association with respective guiding reference points of the image object 12a to inform the editor of an eye flow of the image object 12a.

FIG. 22 is a schematic diagram showing a case in which the image objects 12a to 12d are arranged referring to the line-of-sight guiding information 14.

With reference to the line-of-sight guiding information 14, as shown in FIG. 22, the editor only has to arrange the image object 12b in a position where a line-of-sight intensity is the largest along a line-of-sight guiding direction and, in the same manner, arrange the image objects 12c and 12d in positions where line-of-sight guiding intensities are the second and third largest along the line-of-sight direction. If the image objects 12b to 12d are arranged in this way, a line-of-sight tends to flow in an order of the image objects 12b to 12d when a reader looks at the image object 12a, and an effect of appeal of priorities expected by the editor is obtained.

In this way, in this exemplary embodiment, the image object 10 is approximated to a polygon on the basis of vector image data, guiding reference points are set out of the approximated image object 10, and line-of-sight guiding directions and line-of-sight guiding intensities are calculated with respect to the set guiding reference points.

A line-of-sight tends to be guided from the inside of the image object 10 toward apexes. Therefore, by setting guiding reference points after approximating the image object 10 to a polygon, even if the image object 10 does not include a clear projected part, it can be calculated quantitatively and relatively appropriately in which direction the image object 10 tends to guide a line-of-sight. Thus, a relatively appropriate eye flow can be obtained quantitatively compared with the related art technique. In addition, since it is unnecessary to separately provide a device such as an eye camera, an apparatus is never increased in size and large cost is never incurred, and reduction in size and reduction in cost of the apparatus can be realized compared with the related art technique. Moreover, since a line-of-sight guiding degree is not calculated by a method of learning, an appropriate eye flow can be obtained relatively surely.

Moreover, in this exemplary embodiment, auxiliary points are set in positions where a distance from a straight line connecting both the end points P0 and P1 of the curved line part to the edge 10a is maximized, auxiliary points are set in positions where a distance from straight lines connecting points adjacent to each other on the edge 10a among both the end points P0 and P1 and the respective auxiliary points set so far is maximized, and points adjacent to each other on the edge 10a among both the end points P0 and P1 and the respective auxiliary points set so far are connected by straight lines to form a polygon.

Consequently, the curved line part can be approximated to a polygon of a relatively similar shape, and the guiding reference points can be approximated as a polygon that is easily set. Thus, even if the image object 10 does not include a clear projected part, it can be calculated more appropriately in which direction the image object 10 tends to guide a line-of-sight.

Moreover, in this exemplary embodiment, the setting of auxiliary points is performed repeatedly until a distance between the image object 10 and the polygon is reduced to a predetermined distance or less.

Consequently, since the curved line part can be approximated to a polygon of a more similar shape, even if the image object 10 does not include a clear projected part, it can be calculated more appropriately in which direction the image object 10 tends to guide a line-of-sight.

In addition, in this exemplary embodiment, apexes of the image object 10 approximated to a polygon are set as guiding reference points.

A line-of-sight tends to be guided from the inside of the image object 10 toward apexes. Therefore, by setting the apexes of the image object 10 as guiding reference points, it can be calculated more appropriately in which direction the image object 10 tends to guide a line-of-sight.

Further, in this exemplary embodiment, two auxiliary lines crossing guiding reference points are formed imaginarily along the contour of the image object 10, and directions in which bisectors of obtuse angles among angles formed by the imaginary auxiliary lines extend outward from the guiding reference points are calculated as line-of-sight guiding directions.

Consequently, since the directions form the inside of the image object 10 toward the apexes can be calculated as the line-of-sight guiding directions, it can be calculated more appropriately in which direction the image object 10 tends to guide a line-of-sight.

Moreover, in this exemplary embodiment, center-of-gravity distances from the guiding reference points are calculated as line-of-sight intensities.

As an apex angle of the image object 10 becomes sharper, a line-of-sight tends to be guided more to the apex angle. In addition, the center-of-gravity distance increases as the apex angle becomes sharper. Therefore, since line-of-intensity guiding intensity corresponding to a size of the apex angle of the image object 10 can be calculated, it can be calculated more appropriately in which direction the image object 10 tends to guide a line-of-sight.

In the first exemplary embodiment, step S102 corresponds to the projected part approximating device of the first to the sixth exemplary embodiments, the thirty-fourth to the thirty-ninth or the sixty-seventh to the seventy-second exemplary embodiments or the projected part approximating of the twelfth to the seventeenth exemplary embodiments, the forty-fifth to the fiftieth exemplary embodiments or the seventy-eighth exemplary embodiment, step S104 corresponds to the guiding reference point detecting device of the first, the sixth, the seventh, the thirty-fourth, the thirty-ninth, the fortieth, the sixty-seventh, the seventy-second, or the seventy-third exemplary embodiment or the guiding reference point detecting of the twelfth, the seventeenth, the eighteenth, the forty-fifth, the fiftieth, the fifty-first, the seventy-eighth, the twenty-third, the twenty-eighth, the twenty-ninth, the fifty-sixth, the sixty-first, the sixty-second, or the seventy-ninth exemplary embodiments, steps S106 and S108 correspond to the line-of-sight guiding degree calculating device of the first, the seventh, the thirty-fourth, the fortieth, the sixty-seventh, or the seventy-third exemplary embodiment or the line-of-sight guiding degree calculation of the twelfth, the eighteenth, the forty-fifth, the fifty-first, the seventy-eighth, the twenty-third, the twenty-ninth, the fifty-sixth, the sixty-second, or the seventy-ninth exemplary embodiment. In addition, step S106 corresponds to the line-of-sight guiding direction calculating device of the seventh, the eighth, the fortieth, the forty-first, the seventy-third, or the seventy-fourth exemplary embodiment or the line-of-sight guiding direction calculating of the eighteenth, the nineteenth, the fifty-first, the fifty-second, the twenty-ninth, the thirtieth, the sixty-second, or the sixty-third exemplary embodiment, step S108 corresponds to the line-of-sight guiding intensity calculating device of the seventh, the ninth, the fortieth, the forty-second, the seventy-third, or the seventy-fifth exemplary embodiment or the line-of-sight guiding intensity calculating of the eighteenth, the twentieth, the fifty-first, the fifty-third, the twenty-ninth, the thirty-first, the sixty-second, or the sixty-fourth exemplary embodiment, step S204 corresponds to the first auxiliary point setting device of the fourth, the thirty-seventh, or the seventieth exemplary embodiment or the first auxiliary point setting of the fifteenth, the forty-eighth, the twenty-sixth, or the fifty-ninth exemplary embodiment, step S212 corresponds to the second auxiliary point setting device of the fourth, the fifth, the thirty-seventh, the thirty-eighth, the seventieth, or the seventy-first exemplary embodiment or the second auxiliary point setting of the fifteenth, the sixteenth, the forty-eighth, the forty-ninth, the twenty-sixth, the twenty-seventh, the fifty-ninth, or the sixtieth exemplary embodiment.

### Second Exemplary Embodiment

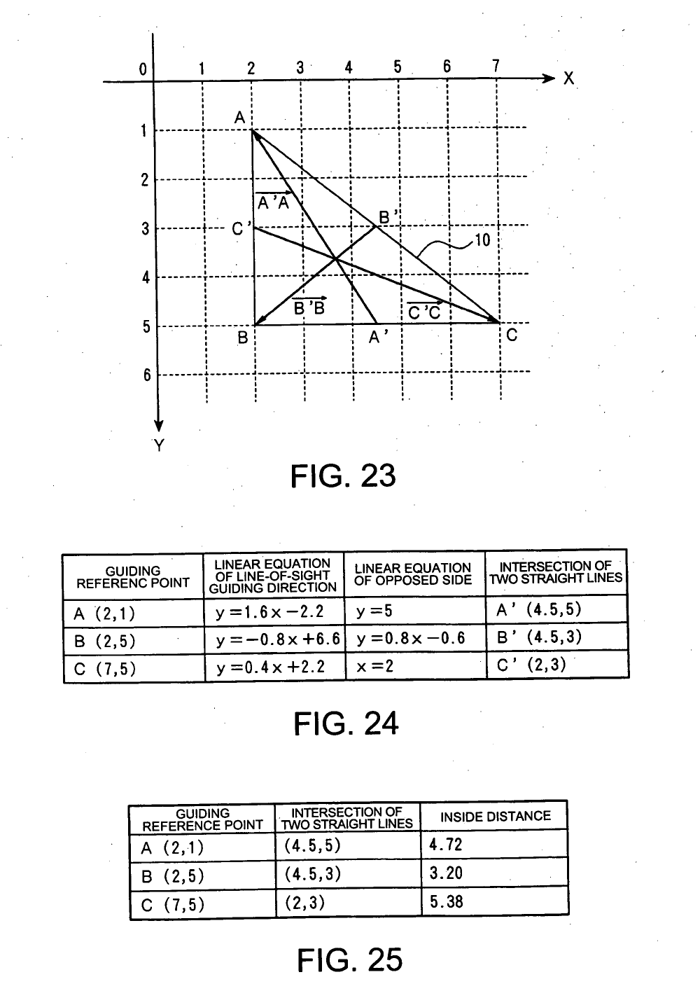

Next, a second exemplary embodiment of the invention will be explained with reference to the drawings. FIGS. 23 to 26 are diagrams showing a second exemplary embodiment of the line-of-sight guiding degree calculation system and the line-of-sight guiding degree calculation program as well as the line-of-sight calculation method in accordance with the invention.

In this exemplary embodiment, the line-of-sight guiding degree calculation system and the line-of-sight guiding degree calculation program as well as the line-of-sight calculation method in accordance with the exemplary embodiment are applied to a case in which a direction in which the image object 10 guides a line-of-sight and an intensity at which the image object 10 guides the line-of-sight. This exemplary embodiment is different from the first exemplary embodiment in that distances from sides opposed to guiding reference points (hereinafter referred to as opposed sides) of the contour line of the image object 10 to the guiding reference points are calculated as line-of-sight guiding intensities. Only the difference from the first exemplary embodiment will be hereinafter explained, and components overlapping those in the first exemplary embodiment will denoted by identical reference numerals and signs, and an explanation of the components will be omitted.

Line-of-sight guiding intensity calculation processing in step S108 will be explained in detail with reference to FIGS. 23 to 26.

In step S108, for each of guiding reference points, an auxiliary line passing the guiding reference point in a line-of-sight guiding direction is formed imaginarily, and a distance from a point where the imaginary auxiliary line crosses an opposed side to the guiding reference point (hereinafter referred to as inside distance) is calculated as a line-of-sight guiding intensity.

FIG. 23 is a schematic diagram showing inside distances from guiding reference points.

FIG. 24 is a table showing an example of calculation for calculating coordinates of points where imaginary auxiliary lines cross opposed sides.

To obtain the inside distances, first, coordinates of points where the imaginary auxiliary lines cross the opposed sides are obtained. Concerning the guiding reference point A, as shown in FIGS. 23 and 24, since an equation for the imaginary auxiliary line is represented as y=1.6x−2.2 and an equation for the opposed side is represented as y=5, coordinates of an intersection A′ of the two straight lines can be calculated by solving the equations of the straight lines. As a result, the coordinates of the intersection A′ can be calculated as (4.5, 5).

Concerning the guiding reference point B, since an equation for the imaginary auxiliary line is represented as y=0.8x+6.6 and an equation for the opposed side is represented as y=0.8x−0.6, coordinates of an intersection B′ of the two straight lines can be calculated as (4.5, 3) by solving the equations of the straight lines.

Concerning the guiding reference point C, since an equation for the imaginary auxiliary line is represented as y=0.4x+2.2 and an equation for the opposed side is represented as x=2, coordinates of an intersection C′ of the two straight lines can be calculated as (2, 3) by solving the equations of the straight lines.

FIG. 25 is a table showing an example of calculation for calculating inside distances.

Next, inside distances from the respective guiding reference points A to C are calculated on the basis of the coordinates of the intersections A′ to C′. Since the inside distance from the guiding reference point A is a distance from the intersection A′ to the guiding reference point A, as shown in FIG. 25, the inside distance can be calculated as “4.72”.

Since the inside distance from the guiding reference point B is a distance from the intersection B′ to the guiding reference point B, the inside distance can be calculated as “3.20”.

Since the inside distance from the guiding reference point C is a distance from the intersection C′ to the guiding reference point C, the inside distance can be calculated as “5.38”.

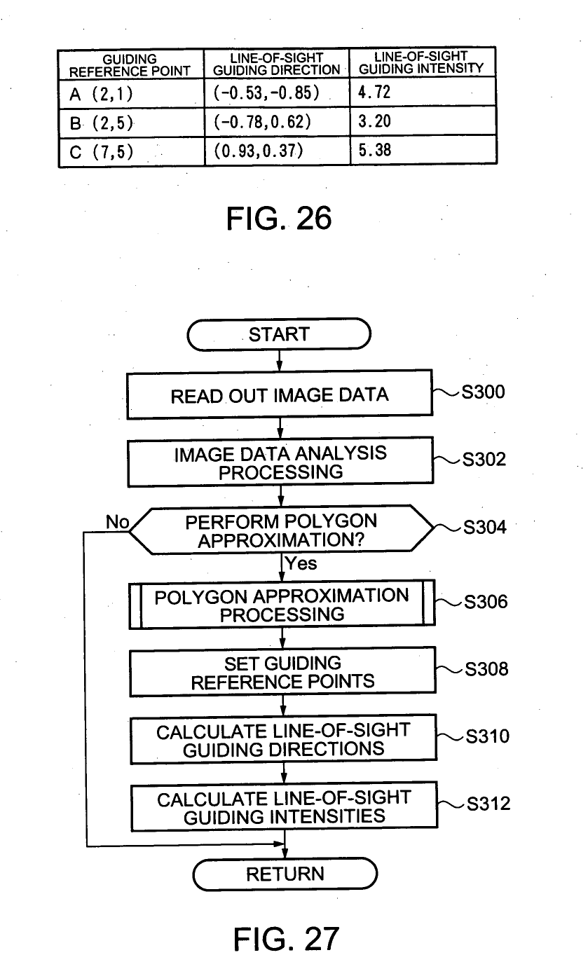

FIG. 26 is a table showing line-of-sight guiding directions and line-of-sight guiding intensities at respective guiding reference points.

From the above, as shown in FIG. 26, a line-of-sight guiding direction and a line-of-sight guiding intensity at the guiding reference point A can be calculated as (−0.53, −0.85) and “4.72”. This indicates that a line-of-sight is guided in a direction of (−0.53, −0.85) with the apex A of the image object 10 as a reference at a magnitude of “4.72”.

A line-of-sight guiding direction and a line-of-sight guiding intensity at the guiding reference point B can be calculated as (−0.78, 0.62) and “3.20”. This indicates that a line-of-sight is guided in a direction of (−0.78, 0.62) with the apex B of the image object 10 as a reference at a magnitude of “3.20”.

A line-of-sight guiding direction and a line-of-sight guiding intensity at the guiding reference point C can be calculated as (0.93, 0.37) and “5.38”. This indicates that a line-of-sight is guided in a direction of (0.93, 0.37) with the apex C of the image object 10 as a reference at a magnitude of “5.38”.

Next, operations of this exemplary embodiment will be explained.

In the layout apparatus 100, vector image data is read out through step S100. At this point, in the case in which the image object 10 having a curved line part is included in a vector image, the image object 10 is approximated to a polygon on the basis of the read-out vector image data through steps S102 and S104, and respective apexes of the approximated image object 10 are set as guiding reference points.

Then, through step S106, for each of the guiding reference points, two auxiliary lines crossing guiding reference points are formed imaginarily along the contour of the image object 10, and a direction in which a bisector of an obtuse angle among angles formed by the imaginary auxiliary lines extends outward from the guiding reference point is calculated as line-of-sight guiding directions. In addition, through step S108, for each of the guiding reference points, an inside distance is calculated as a line-of-sight guiding intensity.

In this way, in this exemplary embodiment, an inside distance form a guiding reference point is calculated as a line-of-sight guiding intensity.

As an apex angle of the image object 10 becomes sharper, a line-of-sight tends to be guided more to the apex angle. In addition, the inside distance increases as the apex angle becomes sharper. Therefore, since a line-of-intensity guiding intensity corresponding to a size of the apex angle of the image object 10 can be calculated, it can be calculated more appropriately in which direction the image object 10 tends to guide a line-of-sight.

In the second exemplary embodiment, step S102 corresponds to the projected part approximating device of the first to the sixth exemplary embodiments, the thirty-fourth to the thirty-ninth or the sixty-seventh to the seventy-second exemplary embodiments or the projected part approximating of the twelfth to the seventeenth exemplary embodiments, the forty-fifth to the fiftieth exemplary embodiments or the seventy-eighth exemplary embodiment, step S104 corresponds to the guiding reference point detecting device of the first, the sixth, the seventh, the thirty-fourth, the thirty-ninth, the fortieth, the sixty-seventh, the seventy-second, or the seventy-third exemplary embodiment or the guiding reference point detecting of the twelfth, the seventeenth, the eighteenth, the forty-fifth, the fiftieth, the fifty-first, the seventy-eighth, the twenty-third, the twenty-eighth, the twenty-ninth, the fifty-sixth, the sixty-first, the sixty-second, or the seventy-ninth exemplary embodiments, steps S106 and S108 correspond to the line-of-sight guiding degree calculating device of the first, the seventh, the thirty-fourth, the fortieth, the sixty-seventh, or the seventy-third exemplary embodiment or the line-of-sight guiding degree calculation of the twelfth, the eighteenth, the forty-fifth, the fifty-first, the seventy-eighth, the twenty-third, the twenty-ninth, the fifty-sixth, the sixty-second, or the seventy-ninth exemplary embodiment. In addition, step S106 corresponds to the line-of-sight guiding direction calculating device of the seventh, the eighth, the fortieth, the forty-first, the seventy-third, or the seventy-fourth exemplary embodiment or the line-of-sight guiding direction calculating of the eighteenth, the nineteenth, the fifty-first, the fifty-second, the twenty-ninth, the thirtieth, the sixty-second, or the sixty-third exemplary embodiment, step S108 corresponds to the line-of-sight guiding intensity calculating device of the seventh, the tenth, the fortieth, the forty-third, the seventy-third, or the seventy-sixth exemplary embodiment or the line-of-sight guiding intensity calculating of the eighteenth, the twenty-first, the fifty-first, the fifty-fourth, the twenty-ninth, the thirty-second, the sixty-second, or the sixty-fifth exemplary embodiment, step S204 corresponds to the first auxiliary point setting device of the fourth, the thirty-seventh, or the seventieth exemplary embodiment or the first auxiliary point setting of the fifteenth, the forty-eighth, the twenty-sixth, or the fifty-ninth exemplary embodiment, step S212 corresponds to the second auxiliary point setting device of the fourth, the fifth, the thirty-seventh, the thirty-eighth, the seventieth, or the seventy-first exemplary embodiment or the second auxiliary point setting of the fifteenth, the sixteenth, the forty-eighth, the forty-ninth, the twenty-sixth, the twenty-seventh, the fifty-ninth, or the sixtieth exemplary embodiment.

### Third Exemplary Embodiment

A third exemplary embodiment of the invention will be hereinafter explained with reference to the drawings. FIGS. 27 to 30 are schematic diagrams showing a third exemplary embodiment of the line-of-sight guiding degree calculation system and the line-of-sight guiding degree calculation program as well as the line-of-sight calculation method in accordance with the exemplary embodiment.

In this exemplary embodiment, the line-of-sight guiding degree calculation system and the line-of-sight guiding degree calculation program as well as the line-of-sight calculation method in accordance with the invention are applied to a case in which a direction in which an image object guides a line-of-sight and an intensity at which the image object guides the line-of-sight. This exemplary embodiment is different from the first exemplary embodiment in that judgment processing judging whether approximation processing is to be performed is performed on the basis of the number of image objects after edge extraction. Only the difference from the first exemplary embodiment will be hereinafter explained, and components overlapping those in the first exemplary embodiment will be denoted by identical reference numerals and signs, and an explanation of the components will be omitted.

In this exemplary embodiment, as shown in FIG. 27, image data analysis processing and processing for judging whether polygon approximation processing is to be performed on the basis of a result of the image data analysis processing are inserted anew between step S100 and step S102 of the flowchart shown in FIG. 2 in the first exemplary embodiment.

In short, the CPU 30 starts a predetermined program stored in a predetermined area of the ROM 32 and executes the line-of-sight guiding degree calculation processing shown in the flowchart of FIG. 27 in accordance with the program.

FIG. 27 is a flowchart showing line-of-sight guiding degree calculation processing in the third exemplary embodiment.

The line-of-sight guiding degree calculation processing is processing to calculate a direction in which an image object guides a line-of-sight and an intensity at which the image object guides the line-of-sight. When the line-of-sight guiding degree calculation processing is executed in the CPU 30, as shown in FIG. 27, first, the CPU 30 shifts to step S300.

In step S300, the CPU 30 reads out image data from the storage 42 and shifts to step S302. In step S302, the CPU 30 performs analysis processing for the read-out image data on the basis of the image data and shifts to step S304. In step S304, the CPU 30 judges whether polygon approximation processing is to be performed on the basis of a result of the analysis processing and, if it is judged that the polygon approximation processing is to be performed (Yes), shifts to step S306. Here, if it is judged in step S304 that the analysis processing is not to be performed (No), it is judged that it is unnecessary to subject the image data to the polygon approximation processing.

In step S306, the CPU 30 approximates the image object to a polygon and shifts to step S308. In step S308, the CPU 30 sets guiding reference points to be references for guiding a line-of-sight with respect to the image object approximated to the polygon and shifts to step S310.

In step S310, the CPU 30 calculates line-of-sight guiding directions indicating directions, in which a line-of-sight is guided, with respect to the set guiding reference points and shifts to step S312. In step S312, the CPU 30 calculates line-of-sights guiding intensities indicating intensities, at which a line-of-sight is guided, with respect to the set guiding reference points, ends the series of processing, and returns the processing to the original processing.

Here, since the processing in step S300 and steps S306 to S312 is the same as the processing in step S100 and steps S102 to S108 in the first exemplary embodiment, in this exemplary embodiment, processing in steps S302 and S304 will be explained.

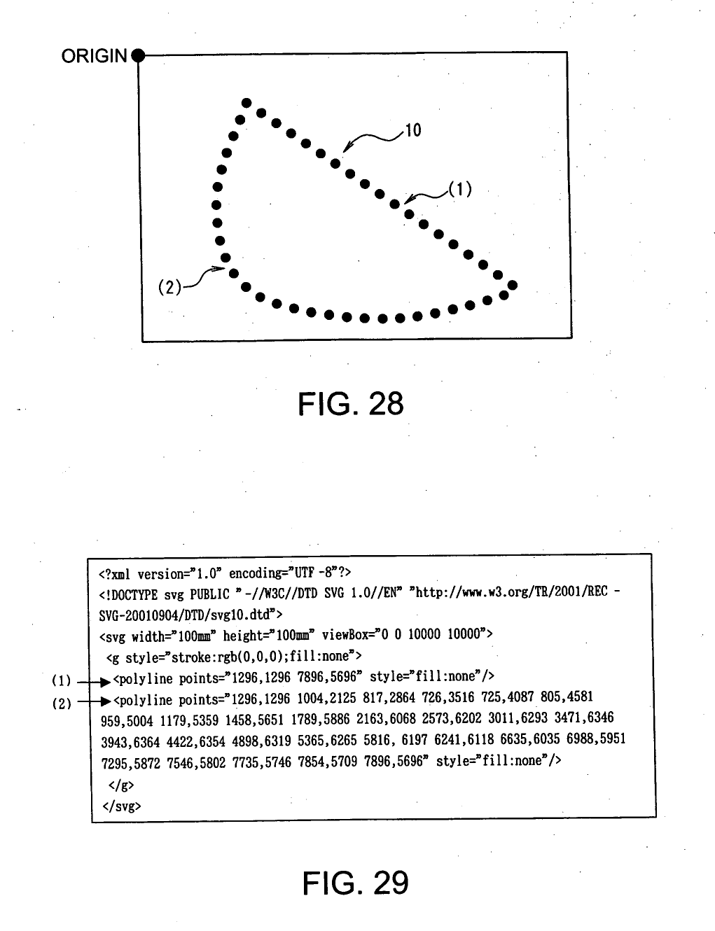

Image data analysis processing in step S302 and approximation judgment processing in step S304 will be hereinafter explained in detail with reference to FIGS. 28 to 30.

FIG. 28 is a diagram showing the image object 10 including the curved line part after edge extraction.

In step S302, first, an edge of this image object 10 is extracted with respect to the image object 10 in FIG. 28 acquired in step S300. The extracted edge is indicated by a row of dots along a shape of the image object as shown in FIG. 28. In addition, vector image data of an SVG format of such an image object 10 is represented as shown in FIG. 29.

FIG. 29 is a diagram showing a structure of the vector image data of the image object 10 having the curved line part.

In the image data analysis processing, a structure in a tag (<polyline points>) indicating that a polygon is drawn in the vector image data is analyzed. Through this analysis, it is seen that coordinates at both end points of a straight line part (1) of the image object 10 in FIG. 28 are included in the tag (<polyline points>) in (1) of FIG. 29, and it is seen that coordinates (total twenty-seven points) of respective points of a curved line part (2) of the image object 10 in FIG. 28 are included in the tag (<polyline points>) in (2) of FIG. 29.

In general, in the vector image data of the SVG format, the straight line part (1) and the curved line part (2) in FIG. 28 are represented as a polygon. In the SVG format, this coordinate point usually increases according to the number of angles of the polygon in such a manner as two for a straight line, four for a triangle, and five for a square. In addition, if the polygon is a polygon of a simple shape such as a triangle or a square, as indicated by the vector image data for a triangle in FIG. 4, a first coordinate point and a last coordinate point among four coordinate points have the same coordinates, and by connecting these points with a straight line, a figure closed by the straight line is formed.

In other words, in this exemplary embodiment, in the image data analysis processing in step S302, by analyzing a structure in the tag (<polyline points>) included in the vector image data taking into account the above-mentioned characteristics of the vector image data of the SVG format, the number of coordinate points of respective figure parts constituting the image object 10 and information indicating whether a figure is closed, are obtained.

On the other hand, in step S304, the CPU 30 judges whether polygon approximation processing is to be performed on the basis of a result of analysis of the image data analysis processing. This judgment processing is performed on the basis of information for judgment processing stored in the storage 42. Condition information for judging whether the polygon approximation processing is to be performed is included in this information for judgment processing. In this exemplary embodiment, the condition information for judgment processing is the information acquired by the analysis with contents indicating that it is judged that the polygon approximation processing is performed in the case in which the number of coordinate points is six or more and a figure obtained as a result of connecting these coordinate points with a straight line is not a closed figure.

Next, operations of this exemplary embodiment will be explained with the vector image data in FIG. 29 as an example.

In the layout apparatus 100, through step S100, the vector image data of the image object 10 including the curved line part shown in FIG. 28 is read out. In step S302, by analyzing the tag (<polyline points>) of (1) in the vector image data shown in FIG. 29, information, which indicates that a figure is not closed because the number of coordinate points is two consisting of (1296, 1296) and (7896, 5696) and coordinates at a start point and coordinates at an end point are different, is obtained. On the other hand, by analyzing the tag (<polyline points>) of (2) in FIG. 29, information, which indicates that a figure is not closed because the number of coordinate points is twenty-seven consisting of (1296, 1296), (1004, 2125), . . . , (7854, 5709), and (7896, 5696) and coordinates at a start point and coordinates at an end point are different.

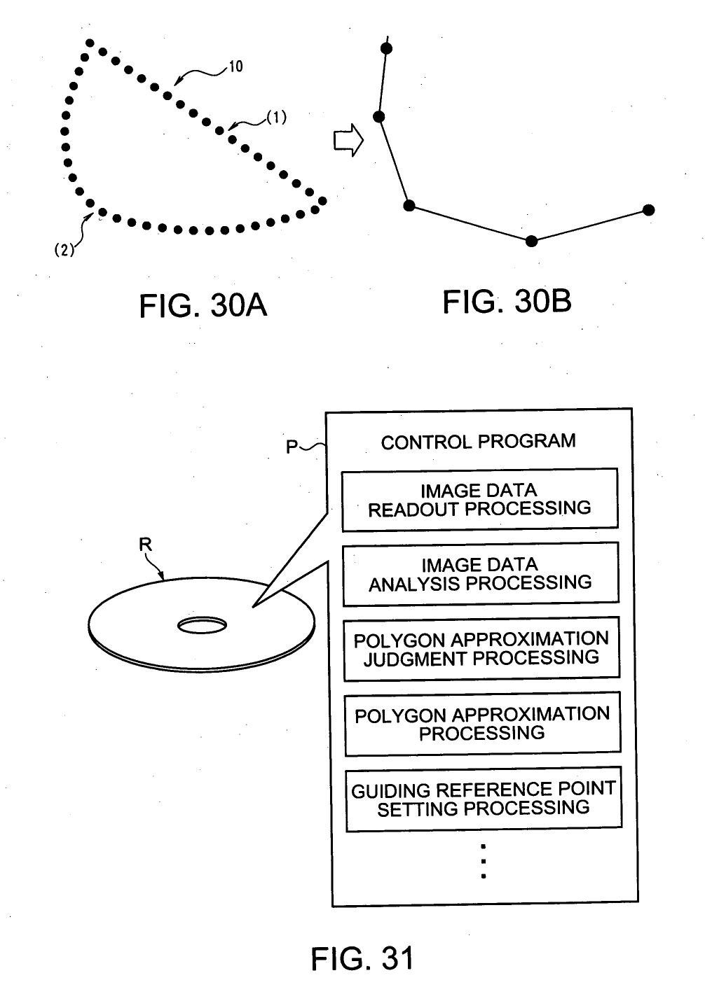

Therefore, in step S304, on the basis of the analysis result in step S302 and the condition information read out from the storage 42, first, the CPU 30 collates the analysis result of (1) in FIG. 29 with the condition information. Since the number of coordinate points is two from the analysis result of (1) in FIG. 29, the condition that the number of coordinate points is six or more in the condition information is not satisfied. Thus, the CPU 30 judges that the polygon approximation processing is not applied to the straight line part (1) in FIG. 28 corresponding to this (1). Next, the CPU 30 collates the analysis result of (2) in FIG. 29 and the condition information. From the analysis result of (2) in FIG. 29, since the number of coordinate points is twenty-seven, the condition that the number of coordinate points is six or more in the condition information is satisfied. Moreover, from the information indicating that the figure is not closed, the condition that a figure is not closed in the condition information is also satisfied. Consequently, the CPU 30 judges that the polygon approximation processing is applied to the curved line part of (2) in FIG. 28 corresponding to (2) in FIG. 29. When it is judged in step S304 that the polygon approximation processing is performed, the CPU 30 shifts to step S306. As shown in FIG. 30, the corresponding figure part ((2) of FIG. 30(A)) is subjected to polygon approximation as shown in FIG. 30(B) by the polygon approximation processing. Then, through step S308, the respective apexes of the approximated image object 10 are set as guiding reference points.

FIG. 30(A) is a schematic diagram showing the image object 10 including the curved line part and FIG. 30(B) is a schematic diagram in which the part of (2) in FIG. 30(A) is subjected to polygon approximation.

Moreover, through step S310, for each of guiding reference points, two auxiliary lines crossing the guiding reference point is formed imaginarily along the contour of the image object 10, and a direction in which a bisector of an obtuse angle among angles formed by the imaginary auxiliary lines extends outward from the guiding reference point is calculated as a line-of-sight guiding direction. In addition, through S312, for each of the guiding reference points, an inside distance is calculated as a line-of-sight guiding intensity.

In this way, in this exemplary embodiment, inside distances from guiding reference points are calculated as line-of-sight guiding intensities.

Note that the processing in steps S302 and S304 is also effective in judging whether polygon approximation is applied to an image object having a shape like the ria coast shown in FIGS. 11 and 12 in the first exemplary embodiment.

As an apex angle of the image object 10 becomes sharper, a line-of-sight tends to be guided more to the apex angle. In addition, the center-of-gravity distance increases as the apex angle becomes sharper. Therefore, since line-of-intensity guiding intensity corresponding to a size of the apex angle of the image object 10 can be calculated, it can be calculated more appropriately in which direction the image object 10 tends to guide a line-of-sight.

In the third exemplary embodiment, steps S302 to S306 correspond to the projected part approximating device of the first to the sixth exemplary embodiments, the thirty-fourth to the thirty-ninth or the sixty-seventh to the seventy-second exemplary embodiments or the projected part approximating of the twelfth to the seventeenth exemplary embodiments, the forty-fifth to the fiftieth exemplary embodiments or the seventy-eighth exemplary embodiment, step S308 corresponds to the guiding reference point detecting device of the first, the sixth, the seventh, the thirty-fourth, the thirty-ninth, the fortieth, the sixty-seventh, the seventy-second, or the seventy-third exemplary embodiment or the guiding reference point detecting of the twelfth, the seventeenth, the eighteenth, the forty-fifth, the fiftieth, the fifty-first, the seventy-eighth, the twenty-third, the twenty-eighth, the twenty-ninth, the fifty-sixth, the sixty-first, the sixty-second, or the seventy-ninth exemplary embodiments, steps S310 and S312 correspond to the line-of-sight guiding degree calculating device of the first, the seventh, the thirty-fourth, the fortieth, the sixty-seventh, or the seventy-third exemplary embodiment or the line-of-sight guiding degree calculation of the twelfth, the eighteenth, the forty-fifth, the fifty-first, the seventy-eighth, the twenty-third, the twenty-ninth, the fifty-sixth, the sixty-second, or the seventy-ninth exemplary embodiment. In addition, step S310 corresponds to the line-of-sight guiding direction calculating device of the seventh, the eighth, the fortieth, the forty-first, the seventy-third, or the seventy-fourth exemplary embodiment or the line-of-sight guiding direction calculating of the eighteenth, the nineteenth, the fifty-first, the fifty-second, the twenty-ninth, the thirtieth, the sixty-second, or the sixty-third exemplary embodiment, and step S312 corresponds to the line-of-sight guiding intensity calculating device of the seventh, the ninth, the fortieth, the forty-second, the seventy-third, or the seventy-fifth exemplary embodiment or the line-of-sight guiding intensity calculating of the eighteenth, the twentieth, the fifty-first, the fifty-third, the twenty-ninth, the thirty-first, the sixty-second, or the sixty-fourth exemplary embodiment.

Note that, in the first to the third exemplary embodiments, center-of-gravity distances or inside distances from guiding reference points are calculated as line-of-sight guiding intensities. However, the invention is not limited to this, and it is also possible to calculate apex angles of the image object 10 as line-of-sight intensities.

As an apex angle of the image object 10 becomes sharper, a line-of-sight tends to be guided more to the apex angle. Therefore, it can be calculated relatively appropriately in which direction the image object 10 tends to guide a line-of-sight.

Moreover, it is also possible to apply predetermining weighting to center-of-gravity distances or inside distances from guiding reference points or apex angles and calculate the added center-of-gravity distances, inside distances, and apex angles as line-of-sight guiding intensities.

In addition, in the first and the second exemplary embodiments, the case in which the image object 10 is a right-angled triangle is explained as an example. However, the exemplary embodiment is not limited to this, and line-of-sight guiding directions and line-of-sight guiding intensities can be calculated in the same manner as the first and the second exemplary embodiments even if the image object 10 has other triangular shapes, polygonal shapes having angles equal to or more than four, or other geometrical shapes.

In addition, in the first to the third exemplary embodiments, line-of-sight guiding directions and line-of-sight guiding intensities of the image object 10 are calculated. However, the present exemplary embodiment is not limited to this, and even in the case of characters or other signs, line-of-sight guiding directions and line-of-sight guiding intensities can be calculated in the same manner as the first to the third exemplary embodiments if each of the characters or the signs or a set of the characters or the signs is regarded as an image.

Further, in the first to the third exemplary embodiments, the case in which a control program stored in the ROM 32 in advance is executed in executing the processing shown in the flowcharts of FIGS. 2, 6, and 27 is explained. However, the exemplary embodiment is not limited to this, and a program indicating these procedures may be read into the RAM 34 from a storage medium in which the program is stored.

Here, the storage medium is a semiconductor storage medium such as a RAM or a ROM, a magnetic storage type storage medium such as an FD or an HD, an optical reading storage medium such as a CD, a CDV, an LD, or a DVD, or a magnetic storage type/optical reading storage medium such as an MO. The storage medium includes any storage medium as long as the storage medium is readable by a computer regardless of a reading method such as an electric, magnetic, or optical reading method. FIG. 31 shows a CD-ROM that is one of computer readable storage media R. It is indicated that a control program P for realizing the invention using a computer system is recorded in this storage medium R consisting of the CD-ROM.

Moreover, in the first to the third exemplary embodiments, the line-of-sight guiding degree calculation system and the line-of-sight guiding degree calculation program as well as the line-of-sight guiding degree calculation method are applied to the case in which a direction in which the image object 10 guides a line-of-sight and an intensity at which the image object 10 guides the line-of-sight are calculated. However, the exemplary embodiments are not limited to this, and is applicable to other cases in a range without departing from the spirit of the invention.

1. A line-of-sight guiding degree calculation system to calculate a degree, at which a line-of-sight is guided by an image, on the basis of image data constituting the image, comprising:
a projected part approximating device that approximates a bent part including a curved line included in the image to a projected part including apexes on the basis the image data; and
a line-of-sight guiding degree calculating device that, with the apexes included in the projected part approximated by the projected part approximating device set as guiding reference points, calculates a light-of-sight guiding degree, at which a line-of-sight is guided, with respect to the guiding reference points.

2. The line-of-sight guiding degree calculation system according to claim 1,
the projected part approximating device subjecting the bent part to polygon approximation.

3. The line-of-sight guiding degree calculation system according to claim 1,
the projected part approximating device setting one or more auxiliary points between both end points of the bent part and on an edge of the bent part and approximating a shape, which is formed by connecting points adjacent to each other on the edge among both the end points of the bent part and the auxiliary points with lines, as the projected part.

4. The line-of-sight guiding degree calculation system according to claim 2,
the projected part approximating device including:
a first auxiliary point setting device that sets the auxiliary points in positions where distances from a straight line connecting both the end points of the bent part to the edge, are maximized; and
a second auxiliary point setting device that sets the auxiliary points in positions where a distance from straight lines connecting points adjacent to each other on the edge among both the end points of the bent part and the auxiliary points to the edge is maximized, and approximates a polygon, the polygon formed by connecting points adjacent to each other on the edge among both the end points of the bent part and the auxiliary points with straight lines, as the projected part.

5. The line-of-sight guiding degree calculation system according to claim 4,
the projected part approximating device performing the setting by the second auxiliary point setting device repeatedly until a distance between the bent part and the polygon is reduced to a predetermined distance or less.

6. The line-of-sight guiding degree calculation system according to claim 1,
the line-of-sight guiding degree calculating device, calculating with apexes of the projected part approximated by the projected part approximating device or vicinities thereof set as guiding reference points, the line-of-sight guiding degree with respect to the guiding reference points.

7. The line-of-sight guiding degree calculation system according to claim 1,
the line-of-sight guiding degree calculating device includes a line-of-sight guiding direction calculating device that calculates line-of-sight guiding directions, which are directions in which a line-of-sight is guided, with respect to the guiding reference points; and
a line-of-sight guiding intensity calculating device that calculates line-of-sight guiding intensities, which are intensities at which a line-of-sight is guided, with respect to the guiding reference points.

8. The line-of-sight guiding degree calculation system according to claim 7,
in the case in which it is assumed that two auxiliary lines crossing the guiding reference points or the vicinities thereof are formed along an edge of an image passing the guiding reference points or the vicinities thereof, the line-of-sight guiding direction calculating device calculating center directions of obtuse angles among angles formed by the imaginary auxiliary lines as the line-of-sight guiding directions.

9. The line-of-sight guiding degree calculation system according to claim 7,
the line-of-sight guiding intensity calculating device calculating distances from a center of an image object, a contour of which is formed including an edge of an image passing the guiding reference points or the vicinities thereof, to the guiding reference points as the line-of-sight guiding intensities.

10. The line-of-sight guiding degree calculation system according to claim 7,
in the case in which it is assumed that two auxiliary lines crossing the guiding reference points or the vicinities thereof are formed along an edge of an image passing the guiding reference points or the vicinities thereof, the line-of-sight guiding intensity calculating device calculating distances from points where bisectors of acute angles among angles formed by the imaginary auxiliary lines cross a contour line of an image object, a contour of which is formed including the edge, to the guiding reference points as the line-of-sight guiding intensities.

11. The line-of-sight guiding degree calculation system according to claim 7,
in the case in which it is assumed that two auxiliary lines crossing the guiding reference points or the vicinities thereof are formed along an edge of an image passing the guiding reference points or the vicinities thereof, the line-of-sight guiding intensity calculating device calculating angles formed by the imaginary auxiliary lines as the line-of-sight guiding intensities.

12. A line-of-sight guiding degree calculation program for use with a computer to calculate degrees, at which a line-of-sight is guided by an image, on the basis of image data constituting the image, comprising:
a program to execute processing including: approximating a bent part including a curved line included in the image to a projected part including apexes, on the basis of the image data; and
calculating, with the apexes included in the projected part approximated in the projected part approximating set as guiding reference points, line-of-sight guiding degrees indicating degrees, at which a line-of-sight is guided, with respect to the guiding reference points.

13. A line-of-sight guiding degree calculation method to calculate degrees, at which a line-of-sight is guided by an image, on the basis of image data constituting the image, comprising:
approximating a bent part including a curved line included in the image, to a projected part including apexes, on the basis of the image data; and
calculating, with the apexes included in the projected part approximated in the projected part approximating set as guiding reference points, line-of-sight guiding degrees indicating degrees, at which a line-of-sight is guided, with respect to the guiding reference points.

14. A line-of-sight guiding degree calculation system to calculate a degree, at which a line-of-sight is guided by an image, on the basis of image data constituting the image, comprising:
a projected part approximating device that approximates a curved part including plural apexes included in the image, to a projected part including apexes fewer than those of the curved part on the basis the image data; and
a line-of-sight guiding degree calculating device that, with the apexes included in the projected part approximated by the projected part approximating device set as guiding reference points, calculates a light-of-sight guiding degree indicating a degree, at which a line-of-sight is guided, with respect to the guiding reference points.

15. A line-of-sight guiding degree calculation system to calculate degrees, at which an image guides a line-of-sight, on the basis of image data, comprising:
a projected part approximating device that approximates a bent part included in the image, to a projected part on the basis the image data;
a guiding reference point detecting device that detects guiding reference points to be references to guide a line-of-sight out of the projected part approximated by the projected part approximating device; and
a line-of-sight guiding degree calculating device that calculates light-of-sight guiding degrees indicating degrees, at which a line-of-sight is guided, with respect to the guiding reference points detected by the guiding reference point detecting device.
